(19) United States
(12) Patent Application Publication
(10) Pub. No.: US 2008/0262929 A1
(43) Pub. Date: Oct. 23, 2008

(54) SYSTEMS AND METHODS FOR PROVIDING WIRELESS ADVERTISING TO MOBILE DEVICE USERS

(75) Inventor: John Behr, Champlin, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: CONVERDIA, INC., Champlin, MN (US)

(21) Appl. No.: 12/105,424

(22) Filed: Apr. 18, 2008

Related U.S. Application Data
(60) Provisional application No. 60/925,037, filed on Apr. 18, 2007.

(51) Int. Cl. G06Q 30/00

(52) U.S. Cl. 705/14

(57) ABSTRACT

A system may provide advertising content to mobile device users. The system may include a virtual advertisement network adapted to accommodate one or more advertisers operating within the virtual advertisement network as well as a wireless communications network adapted to accommodate one or more mobile device users operating within the wireless communications network. A web-based content management server may be adapted to transmit advertisements and other informational content on-demand to one or more mobile device users who have opted into the system and who may, in some cases, be within the aforementioned wireless communications network.

### RELATED APPLICATIONS

This application claims priority to U.S. Provisional Application No. 60/925,037 filed Apr. 18, 2007.

### FIELD

The disclosure pertains generally to the field of wireless advertising. More specifically, the disclosure pertains to systems and methods for providing wireless advertising and information services to mobile device users.

### BACKGROUND

Traditional forms of advertising such as television commercials and print-media have steadily decreased over the past few years as consumers become more selective and as alternative means for receiving information become more prevalent. The popularity of media centers and digital video recorders, for example have allowed viewers to skip through commercials, reducing the exposure advertisers gain through television viewership and, in some cases, prompting television networks to incorporate the advertisements into the actual program. More interactive mediums such as the Internet have also changed the manner in which advertising content is presented to consumers, allowing advertisers to selectively feed information to prospective customers based on the user's behavior and interests. For example, a search performed for a particular automobile on the Internet may prompt an advertisement to appear providing financing options available to the user from a lender. Alternative advertising mediums such as digital signage, gas-station signage, kiosk advertising, as well as other out-of-home advertising have also increased as a result of a shift in consumer behavior and advertising demographics.

The ability to measure the effectiveness of an advertising campaign and to generate qualified sales leads for businesses is often difficult with more traditional forms of advertising since there is typically no manner in which to directly measure consumer response. Technology innovations such as pop-up blockers and do-not-call lists generated in response to federal and state legislation have also changed the manner in which many advertisers pursue prospective clients. At the same time, businesses are demanding more cost effective marketing strategies and shorter lead times, causing many companies to alter the manner in which they present advertising content to consumers.

The increasing popularity of mobile devices such as cellular telephones, personal digital assistants (PDA's), and laptop computers along with significant advances in wireless communications technology have allowed advertisers to present more sophisticated and targeted advertising content to potential customers. In the United States alone, there are over 300 million cellular phone subscribers, generating an estimated 110 million text messages per year. As the speed and graphics capabilities of these devices continues to increase, the ability to provide advertising, coupons, rebates, and other informational content to these users will continue to drive the demand for alternative forms of advertising and content delivery. Accordingly, there is an increasing demand for systems and methods for providing wireless advertising and information services to mobile device users.

### SUMMARY

The disclosure pertains to systems and methods for providing wireless advertising and other information to individuals such as mobile device users. In an illustrative but non-limiting example, the disclosure pertains to a system for providing advertising content to mobile device users. The system may include a virtual advertisement network that is adapted to accommodate one or more advertisers operating within the virtual advertisement network as well as a wireless communications network that is adapted to accommodate one or more mobile device users operating within the wireless communications network.

The system may include a web-based content management server that is adapted to transmit advertisements and other informational content on-demand to one or more mobile device users who have opted into the system and who may, in some cases, be within the aforementioned wireless communications network. The content management server may include a content management engine that may be adapted to adjust the format of the advertisements and other informational content sent to the user's mobile device based at least in part on the browser capabilities of the mobile device and/or the user's preferences.

In another illustrative but non-limiting example, the disclosure pertains to a method of enhancing vehicle sales including a step of entering an advertising agreement with an owner of a vehicle for sale. The owner may be assisted in preparing an electronic advertisement for the vehicle and may be provided with a window cling that is printed with a telephone number and an identifying code that is unique to the vehicle. The window cling may also include contact instructions. A mobile device user, upon viewing the window cling, may text the identifying code to the telephone number as encouraged by the contact instructions on the window cling. In response, the mobile device user may receive the electronic advertisement on their mobile device.

In another illustrative but non-limiting example, the disclosure pertains to a method of increasing advertisement effectiveness. The method may include a step of providing or otherwise obtaining a database of contact information for a number of mobile device users. Approval may be solicited from one or more of the mobile device users to provide them with electronic advertisements that may be forwarded to their mobile devices in exchange for receiving payment for viewing the electronic advertisements that are provided by one or more advertisers. Electronic advertisements may be provided to the mobile device users who have opted to receive them, and the mobile device users may be paid for each electronic advertisement they view.

In another illustrative but non-limiting example, the disclosure pertains to a method of providing user-to-user information exchange services. The method includes a step of providing a system having a wireless communications network that is adapted to accommodate one or more mobile device users operating within the wireless communications network as well as a web-based content management server that is adapted to transmit informational content on-demand to each mobile device user operating within the system.

A signal may be accepted from one of the one or more mobile device users that they wish to share information with a target mobile device user. The information may be converted into a format that is suitable for the target mobile device user and the converted information may be forwarded to the target mobile device user.

The above summary is not intended to describe each disclosed embodiment or every implementation of the disclosure. The Detailed Description which follow more particularly exemplify these embodiments.

### BRIEF DESCRIPTION OF THE DRAWINGS

The following description should be read with reference to the drawings. The drawings, which are not necessarily to scale, depict various examples and are not intended to limit the scope of the disclosure. The disclosure may be more completely understood in consideration of the following detailed description of various embodiments in connection with the accompanying drawings, in which:

FIG. 1 is a diagrammatic view showing an illustrative system for providing advertising and information services to one or more mobile device users;

FIGS. 2A-2B is a flow diagram showing an illustrative method of providing advertising content to the system of FIG. 1;

FIG. 3 is a diagrammatic view showing several illustrative fields that may be used in creating advertisements on the system of FIG. 1;

FIGS. 4A-4B is a flow diagram showing an illustrative method of providing an advertisement based on a request received from a mobile device user;

FIG. 5 is a flow diagram showing an illustrative method of collecting advertisement feedback from mobile device users opting into the system of FIG. 1;

FIG. 6 is a flow diagram showing an illustrative method of billing an advertiser for advertisements placed using the system of FIG. 1;

FIG. 7 is a flow diagram showing an illustrative method of requesting advertising information using a mobile device equipped with an automatic bar-code reader;

FIG. 8 is a diagrammatic view showing an illustrative system for providing direct-to-user advertising and information services from a number of automobile dealerships;

FIG. 9 is a diagrammatic view showing an illustrative system for providing direct-to-user advertising and information services from a number of real estate agents;

FIG. 10 is a screen-shot showing an illustrative housing advertisement that can be created and delivered to a prospective home buyer using the content management server of FIG. 9;

FIG. 11 is a diagrammatic view showing another illustrative system for providing advertising information to one or more consumers within a network;

FIG. 12 is a diagrammatic view showing another illustrative system for providing advertising information to one or more consumers within a particular advertising venue;

FIG. 13 is a diagrammatic view showing another illustrative system for providing user-to-user media and information exchange services among mobile device users; and

FIGS. 14 through 21 are flow diagrams showing illustrative methods that may be carried out using the systems described herein.

While the invention is amenable to various modifications and alternative forms, specifics thereof have been shown by way of example in the drawings and will be described in detail. It should be understood, however, that the intention is not to limit the invention to the particular examples described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict illustrative embodiments and are not intended to limit the scope of the disclosure.

While the systems and methods are described herein with respect to mobile devices such as cellular telephones, personal digital assistants (PDA's), and laptop computers, it should be understood that the systems and methods may be applied to any number of different devices having wireless communications capabilities. Examples of other wireless devices may include, but are not limited to, wireless vending machines, in-store kiosk stations, automobile communications systems, and global positioning system (GPS) devices. In addition, while particular examples of systems and methods are described herein within respect to the automotive, housing, and retail markets, other types of industries may use one or more of the features described herein.

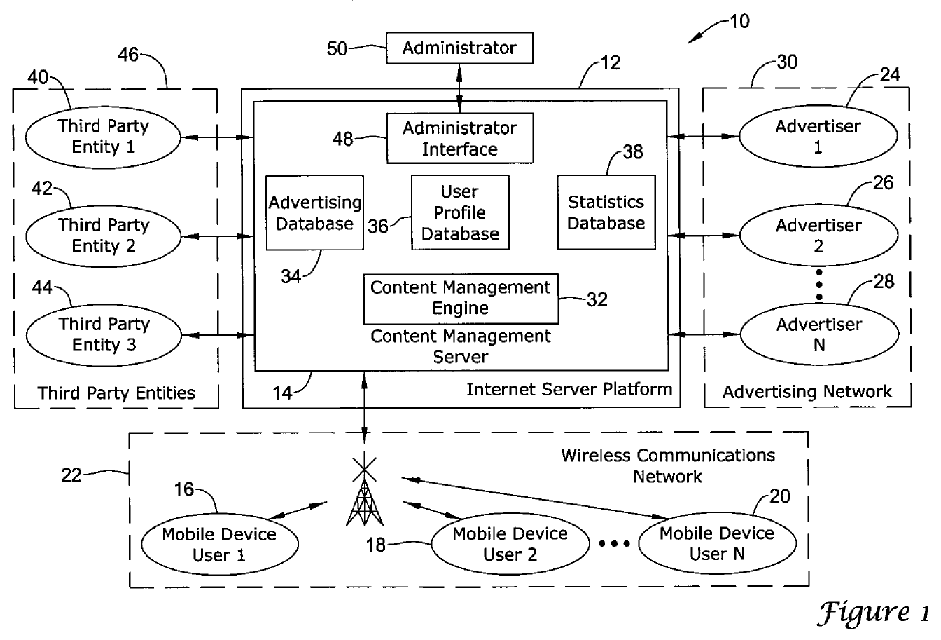

Referring now to FIG. 1, an illustrative system 10 for providing direct-to-user advertising and information services to one or more mobile device users will now be described. The system 10, illustratively a web-based system capable of operating on an Internet-based server platform 12 such as Oracle HTTP, may include a content management server 14 that can be used for delivering advertisements and other informational content to one or more mobile device users 16,18,20 operating on a wireless communications network 22. In some cases, for example, the content management server 14 may be utilized as a gateway to selectively transmit advertisements, coupons, rebates, pricing, and/or other such information generated by one or more advertisers 24,26,28 within an advertising network 30.

Examples of mobile devices 16,18,20 that may opt into the system 10 can include, but are not limited to, cellular telephones, personal digital assistants (PDA's), BLUETOOTH enabled devices, laptop computers, and/or other such wireless communications devices. Other wired or wireless devices such as vending machines, in-store kiosks, GPS units, etc. may also be connected to the content management server 14, either directly or via an Internet portal.

During operation, and as discussed in greater detail herein, the content management server 14 may provide a virtual software environment for each advertiser 24,26,28 within the advertising network 30 to generate electronic advertising content that can be then transmitted by the server 14 to one or more requesting mobile device users 16,18,20 in a format suitable for display on the mobile device's display screen. As further discussed herein, the content management server 14 may further collect and transmit activity history and statistical information regarding any requests received from the mobile device users 16,18,20, including any follow up information requested by the mobile device users 16,18,20 stemming from advertisements delivered to the users' mobile device.

The content management server 14 can include a content management engine 32 adapted to facilitate the transmission of data back and forth from each of the advertisers 24,26,28 within the advertisement network 30 to each mobile device user 16,18,20 within the wireless communications network 22. The content management engine 32 may be implemented as either software and/or hardware, and can be configured to provide the necessary file conversion and browser interfacing necessary to produce text, still images, moving images, and/or audio in a format suited to the user's particular mobile device and the specifications provided by the user's wireless service provider.

If, for example, one of the mobile device users 16,18,20 has a BLUETOOTH enabled cellular telephone, the engine 32 can be configured to transmit text, images, and/or audio via an object exchange communications protocol (OBEX) or other suitable protocol. Depending on the operating platform of the wireless mobile device, other protocols such as HTTP, WMS, and WML may also be supported.

An advertisement database 34 can be provided to permit the storage of advertisements generated by advertisers 24,26,28 within the advertising network 30 along with each advertiser's preferences for receiving notifications, sending advertisements, billing, etc. The data contained in the advertisement database 34 may include any text, still images, moving images, and/or audio clips associated with each advertisement. If, for example, the advertisement is an automobile advertisement, the advertisement database 34 can be configured to store the list price, number of miles, a description of the vehicle, and any images of the vehicle.

Each advertisement stored within the advertising database 34 can be associated with a unique number generated by the content management engine 32. In some instances, for example, the unique code may include a series of alphanumeric characters that can be used to distinguish the advertisement from other advertisements within the advertising database 34. In some cases, the unique code may be automatically generated by the content management engine 32, and can be provided to the advertiser 24,26,28 in the form of an SMS text message code to facilitate contact between the advertiser 24,26,28 and the mobile device user 16,18,20.

For example, a housing advertisement contained within the advertising database 34 may include a five-digit SMS text message code such as “gggad” automatically generated by the content management engine 32, which can then be displayed on the property sign, the advertiser's web-site, an on-line multiple listing service (MLS) database, or other such location. While the content management engine 32 can be configured to automatically generate a unique SMS code to be associated with the advertisement, the unique code may also be customized to permit the code to be easily remembered and recalled by the mobile device user 16,18,20. For example, an illustrative code to be associated with an automobile advertisement may contain a unique SMS text message code such as “myauto”, which can be easily remembered and recalled by the mobile device user 16,18,20 at a later time.

The content management server 14 may further include a user profile database 36 for storing data related to each mobile device user 16,18,20 opting into the system 10. The user profile database 36 may include, for example, the caller's name, the caller's telephone number, a unique identifying number associated with the user's mobile device, the type of mobile device (e.g. cellular telephone, PDA, BLUETOOTH, etc.), the operating system used by the mobile device (e.g. HTTP, WMS, WML, WAP, etc.), and the time zone in which the mobile device is operating.

In some cases, additional information from each mobile device user 16,18,20 can be further stored in the user profile database 36, including personal information relating to the user such as the user's name, street address, home telephone number, work phone number, and E-mail address. If desired, demographic information such as the user's age, gender, race, income, employment status, marital status, number of children, etc. may also be stored in the user profile database 36.

A statistics database 38 can be provided for storing activity history and statistics pertaining to any requests received from one or more of the mobile device users 16,18,20 as well as any follow-up action taken by the mobile device users 16,18,20. The statistics database 38 may also contain information gathered from each advertiser 24,26,28. Examples of statistics that can be stored within the database 38 can include, but are not limited to, the time and date in which a request to view an advertisement was made, the location of the mobile device user 16,18,20 at the time of the request, whether any requests for further information were made by the mobile device user 16,18,20 (e.g. by selecting a hyperlink provided on the user's display screen to view more information about the advertised product or service), the time or duration that each advertisement has been available for viewing on the sever 14, and the last time an advertisement has been viewed or accessed. In use, data contained within the statistics database 38 can be used to measure the success and exposure of an advertising campaign, allowing the advertisers 24,26,28 to better measure their advertising return on investment (ROI) by identifying customers as individuals.

The content management engine 32 may further facilitate the transmission of information from one or more third party entities 40,42,44 within a third-party entity network 46 to one or more of the mobile device users 16,18,20 and/or one or more of the advertisers 24,26,28. An illustrative third party entity 40,42,44 may include, for example, a business that provides vehicle reports for customers interested in learning more about the service and ownership history of a vehicle, a bank or other financial institution that provides credit or lending services for prospective purchases of a vehicle or house, and/or a credit reporting agency capable of providing a credit report on an individual or business. One or more of the third-party entities 40,42,44 may include businesses that normally collect public and private demographic information on individuals, including credit bureaus and marketing agencies.

An administration interface 48 may be utilized to permit an administrator 50 to access and manage data contained within each of the databases 34,36,38. In some instances, for example, the administration interface 48 may be utilized by the administrator 50 to establish new advertising or third-party entity accounts, to perform maintenance on existing accounts, to perform self-tests on the system 10 to ensure proper communication with the wireless communications network 22, as well as other desired tasks.

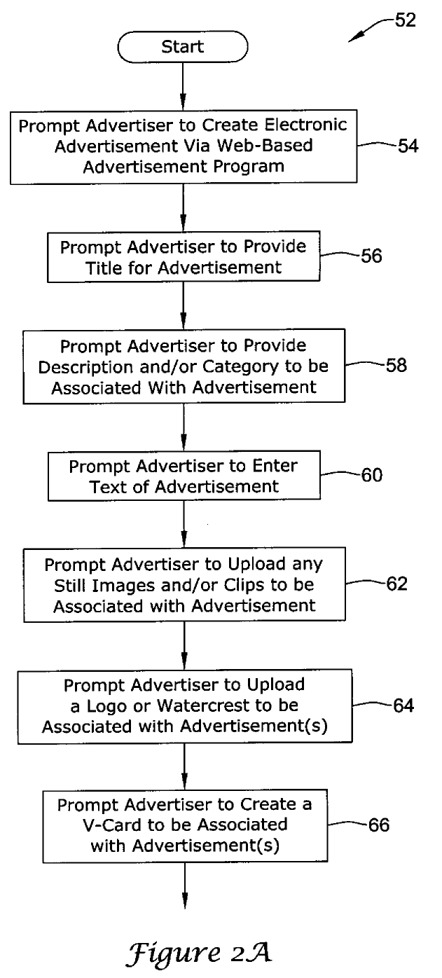

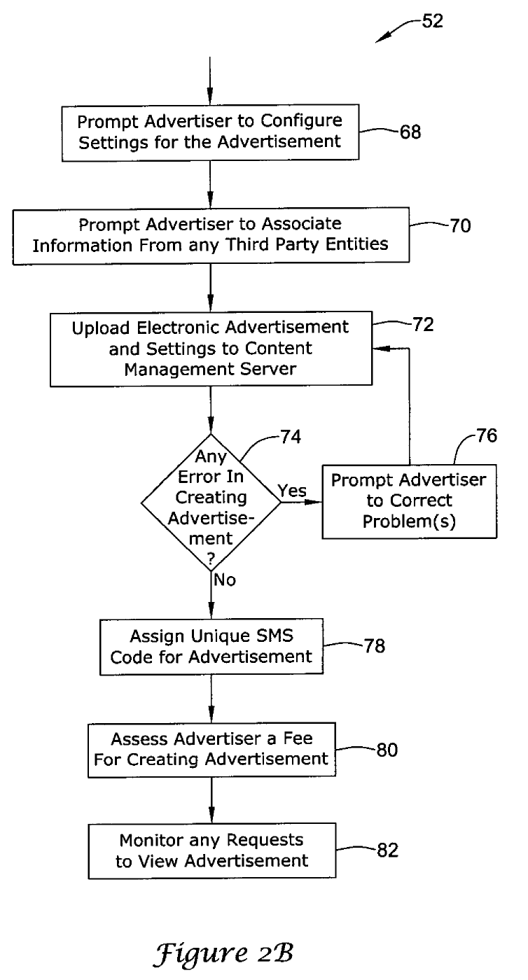

FIGS. 2A-2B is a flow diagram showing an illustrative method 52 of providing advertising content to the content management server 14 of FIG. 1. The method may begin generally at block 54, when the content management engine 32 prompts the advertiser 24,26,28 to create an electronic advertisement via a web-based advertisement program. Once prompted to create an advertisement, the program may then prompt the advertiser 24,26,28 to provide a title and brief description of the advertisement, as indicated generally at blocks 56 and 58. If, for example, the advertisement to be created is for a new car, the advertiser may enter a title such as “New 2007 BMW 7 Series” along with a brief description of the content of the advertisement. If desired, the advertiser 24,26,28 may also select a general category (e.g. “automobile”) to be associated with the advertisement, which can be used to facilitate identification and tracking of advertisements contained within the advertisement database 34.

Once a title and brief description of the advertisement has been entered, the program can then be configured to prompt the user to enter the text for the advertisement, as indicated generally at block 60. The text for the advertisement can then be entered into the program or imported from another file into the program. If desired, and as indicated further at block 62, the advertiser 24,26,28 may then be prompted to add any still images, streaming video, and/or moving images to be displayed along with the text of the advertisement.

In some cases, for example, the advertiser 24,26,28 may be prompted whether they wish to add several still images, which can then be assembled together to create a slideshow that can be displayed along with the text of the advertisement. Once uploaded, the content management engine 32 can be configured to automatically convert the file format of the still and/or moving images received into a universal format for storage within the advertisement database 34. Examples of image formats that may be received and converted can include, but are not limited to, GIF's, TIFF's, JPEG's, PDF's, MJPEG's, MPEG's, WAV's, and MOV's. Other image formats may also be supported.

In some instances, and as indicated further at blocks 64 and 66, the advertisement program may further prompt the advertiser 24,26,28 to upload a logo or watercress to be associated with each advertisement provided by the advertiser 24,26,28 along with a V-Card of the advertiser 24,26,28. If, for example, the advertiser 24,26,28 desires to display their logo adjacent to the text of the advertisement along with contact information, the advertiser 24,26,28 may upload the logo and V-Card information to the program. As additional advertisements are generated by the advertiser 24,26,28, the logo and V-Card information can be reused, or alternatively, a different logo and/or contact information may be provided.

Once the advertiser 24,26,28 has created the text and images to be associated with the advertisement, and as indicated generally at block 68, the advertisement program may then prompt the advertiser 24,26,28 to configure any settings to be associated with the advertisement. If, for example, the advertiser 24,26,28 desires to publish the advertisement in an on-line marketplace that can be accessed by others over the Internet, the advertiser 24,26,28 may select a “Publish” icon button on the program interface.

Alternatively, if the advertiser 24,26,28 desires the advertisement to be viewed only by mobile device users, the advertiser 24,26,28 may select a “Do Not Publish” icon button on the program interface. Contact and access settings in which the advertiser 24,26,28 desires to be contacted such as via E-mail, telephone, etc. may also be set. Other settings such as the maximum or minimum view size of the images, the desired order of the various components of the advertisement, the time zone of the advertiser 24,26,28, etc. may also be set at this step.

The advertisement program may further prompt the advertiser 24,26,28 to associate information from any third-party entities 40,42,44 with the advertisement being created, as further indicated generally at block 70. If, for example, the advertisement to be created is for a particular product sold by a retailer, the advertisement program can be configured to prompt the retailer to allow any coupons, rebates, and/or additional product information for that product to be delivered along with the advertisement. For example, if the advertisement is for a digital camera displayed on the shelf of a retailer, the retailer may request that any product reviews or certifications for the device be provided along with the product specifications for the camera. Other types of information such as industry news, press releases, internal news, etc. may also be provided at this step, if desired.

In some instances, the advertisement program can be configured to automatically create some or all of the advertisement content for the advertiser 24,26,28. If, for example, the advertisement is for a home listed on an MLS database, the advertisement program can be configured to use the housing data contained in the MLS database to automatically generate a text description of the home for the advertisement. Any images of the home contained in the MLS database can also be used to automatically generate the advertisement, if desired.

Once the advertiser 24,26,28 has created the advertisement and has selected the desired manner in which to receive confirmation of requests to view the advertisement, the program may then prompt the advertiser 24,26,28 to upload the advertisement and associated settings to the content management server 14, as further indicated generally at block 72. The program may then determine at decision block 74 if there were any errors in the newly created advertisement. If an error is detected, the program may then prompt the advertiser 24,26,28 to fix the error and resubmit the advertisement, as indicated generally at block 76. The program may also present the advertiser 24,26,28 with an option to access help information (e.g. by selection of a “help” icon button on the computer screen), allowing the advertiser 24,26,28 to troubleshoot the cause of the error.

Upon successfully uploading the advertisement to the content management server 14, the advertisement program may be configured to automatically generate a unique SMS text message code or other unique identifying code to be associated with the advertisement, as indicated generally at block 78. The unique identifying code may then be transmitted to the advertiser 24,26,28 along with a message prompting the advertiser 24,26,28 to use the code or, if desired, to change the code to another unused code.

As indicated further at block 80, the advertiser 24,26,28 may then be charged a fee for the costs associated with creating and maintaining the advertisement on the content management server 14. In certain cases, for example, the advertiser 24,26,28 may be charged a flat fee for creating the advertisement along with a per-impression fee for each view the advertisement receives. The manner in which the advertiser 24,26,28 is billed may occur in other ways, however.

For example, the advertiser 24,26,28 may be assessed a flat fee for each advertisement placed, a flat fee for a group of advertisements placed, a sliding-scale fee based on storage space utilized in the advertisement database 34, etc. In some cases, the fee assessed may depend at least in part on whether the mobile device user 16,18,20 consummates a sale and/or requests further information via a hyperlink embedded within the advertisement. In one such instance, for example, an initial fee may be assessed for placing the advertisement on the content management server 14, a second fee may be assessed each time a mobile device user 16,18,20 views the advertisement, and a third fee assessed if the mobile device user 16,18,20 requests more information from the advertiser 24,26,28 through a hyperlink or E-mail address provided on the advertisement.

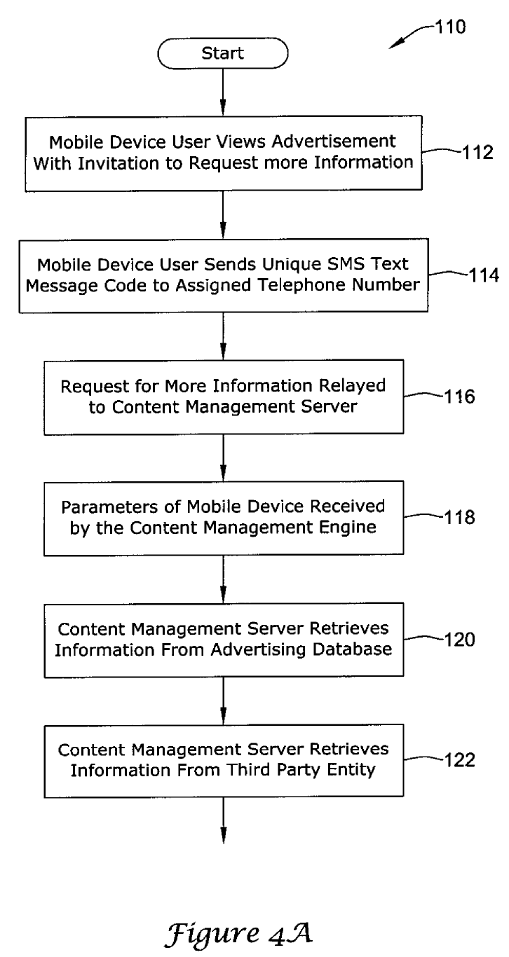

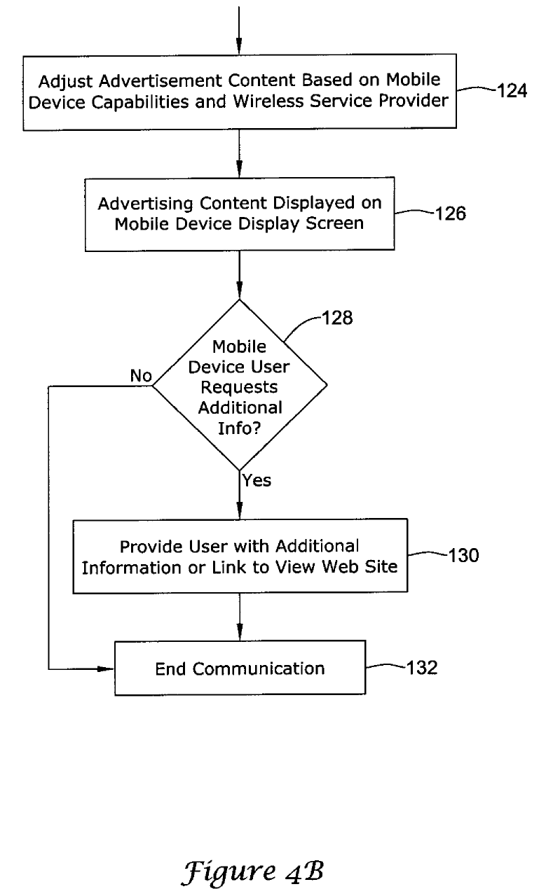

Once stored on the advertisement database 34, the content management server 14 may then monitor any requests to view the advertisement received from one or more of the mobile device users 16,18,20 as well as any third-party entities 40,42,44 requesting such information, as indicated generally at block 82. An illustrative method of providing advertisements based on requests received from mobile device users is discussed further herein with respect to FIG. 4.

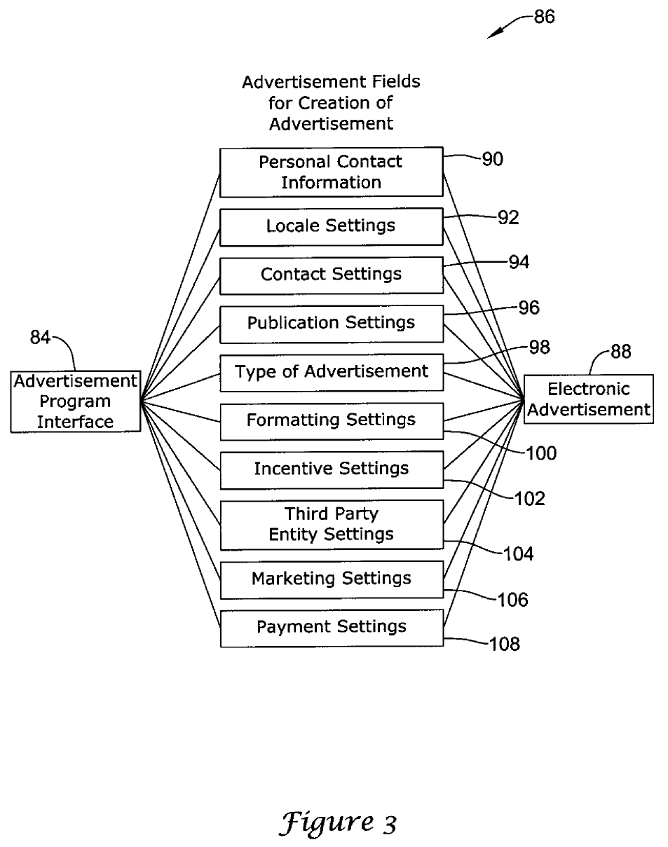

FIG. 3 is a diagrammatic view showing several illustrative fields that may be used in creating advertisements on the content management server 14 of FIG. 1. As shown in FIG. 3, an advertisement program interface 84 of the content management engine 32 may be configured to prompt the user to enter a number of parameter fields 86 for creating an electronic advertisement 88 that can then be stored on the content management server 14. A PERSONAL CONTACT INFORMATION field 90, for example, may contain contact information for the advertiser, including the name and address of the advertiser and the name, address, telephone number, and E-mail address of one or more contact persons. A private password may be used to restrict access to the advertiser's personal contact information.

A LOCALE SETTINGS field 92 may be utilized to select the particular time zone and/or geographic location in which the advertiser is located. The LOCALE SETTINGS field 92 may be used, for example, to designate that the contact person for the advertiser is located in the Central Time zone. The LOCALE SETTINGS field 92 may also be used to select a geographic location by zip code, state, city, and/or address. Such information may be used to determine specific information pertaining to the advertisement. For an automobile dealer, for example, the designation of the dealer's zip code may determine whether a particular rebate, coupon, or other such incentive is available for redemption from the auto manufacturer.

A CONTACT SETTINGS field 94 may be used to designate the manner in which the advertiser 24,26,28 is contacted by mobile device users 16,18,20, by third party entities 40,42,44, and/or by the administrator 50. Example parameters within this field 94 can include contact directly via telephone, E-mail, text message, and/or web-site. If desired, the advertiser 24,26,28 may elect to receive contact via multiple sources such as by both telephone and via E-mail.

A PUBLICATION SETTINGS field 96 may be used to designate the manner in which the advertiser 24,26,28 publishes the advertisement on the content management server 14. If, for example, the advertiser 24,26,28 desires the advertisement to be made publicly available on an on-line marketplace web-site, the advertiser 24,26,28 may select “Publish Advertisement” in the PUBLICATIONS SETTING field 96. Alternatively, if the advertiser 24,26,28 desires to restrict access of the advertisement to selected individuals, or desires the advertisement to remain private, the advertiser 24,26,28 may select “Restrict Access” in the PUBLICATION SETTINGS field 96. Examples of other parameters that may be selected under the PUBLICATION SETTINGS field 96 may include a “yellow pages” parameter allowing the advertiser 24,26,28 to specify the placement of the advertisement in an electronic and/or print directory.

The type of advertisement to be created may be selected via a TYPE OF ADVERTISEMENT field 98, allowing the advertiser 24,26,28 to customize the advertisement based on category. If, for example, the advertiser 24,26,28 selects a category of “housing” via the TYPE OF ADVERTISEMENT field 98, the advertisement program may then default the advertisement formatting to a format commonly used in the sale of homes. Selection of the category “housing” in the TYPE OF ADVERTISEMENT field 98, for example, may cause the program to prompt the advertiser to enter information such as the asking price of the house, the date the house was placed on the market, the type of house, the square footage of the house, the lot size, etc. Other types of categories and subcategories may also be utilized depending on the type of advertisement to be created.

A FORMATTING SETTINGS field 100 may be used to designate the formatting to be used in displaying the advertisement. If, for example, the advertiser 24,26,28 desires a particular formatting style to be applied to each advertisement created, the advertiser 24,26,28 may select from one or more default or user-defined formatting styles. If desired, the FORMATTING SETTINGS field 100 may also be used to configure other settings relating to the advertisement, including the size of any pictures displayed, the maximum amount of text that can be included in the advertisement, and the types of mobile devices that can receive the advertisement. The FORMATTING SETTINGS field 100 may be utilized to ensure that a particular advertising format is used for multiple advertisements generated from a particular advertiser 24,26,28. In one example, the FORMATTING SETTINGS field 100 can be used by the advertiser 24,26,28 to link several pictures together in sequence to create a slideshow of images that can be displayed on the mobile device user's display screen.

An INCENTIVE SETTINGS field 102 may permit the advertiser 24,26,28 to specify any coupons, rebates, rewards, and/or other such incentives to be associated with the advertisement to be created. If, for example, an automobile advertiser desires rebate information for a particular automobile to be displayed along with the advertisement, the advertiser may select a “Provide Rebate” parameter in the INCENTIVE SETTINGS field 102, allowing the advertiser to upload rebate information along with the advertisement and/or provide a link allowing the mobile device user to access coupon and rebate information from another location such as a web-site.

A THIRD-PARTY ENTITY SETTINGS field 104 may be used by the advertiser 24,26,28 to provide additional information along with the advertisement. If, for example, an automobile advertiser desires to provide the mobile device user with the option to get pre-approved for the purchase of a vehicle, the advertiser may select a “Pre-Approval Application” parameter which allows the mobile device user to enter various information that can then be fed to one of the third-party entities for instant approval. Other information such as a vehicle report or ratings report may also be selected for use in conjunction with the advertisement.

A MARKETING SETTINGS field 106 and PAYMENT SETTINGS field 108 may be provided to permit the advertiser 24,26,28 to designate the manner in which the advertisement is marketed along with the payment settings to be associated with the advertisement. The MARKETING SETTINGS field 106, for example, may be used to designate that the advertiser 24,26,28 desires to self-promote the advertisement, or, alternatively, that the advertiser 24,26,28 desires additional marketing assistance such as the publication of the advertisement within a virtual community or on-line marketplace. The PAYMENT SETTINGS field 108, in turn, may be used to select the manner in which the advertiser 24,26,28 desires to pay for the initial placement of the advertisement as well as any further activity stemming from the advertisement.

FIGS. 4A-4B is a flow diagram showing an illustrative method 110 of providing an advertisement based on a request received from a mobile device user 16,18,20. The method 110 may begin generally at block 112 when a mobile device user 16,18,20 views an advertisement containing an invitation to request more information along with a unique SMS text message code and telephone number to call. The invitation to request more information may appear, for example, on the window of an automobile for sale, or on the signage of a house for sale. In some instances, the invitation may appear on an advertised product located in a store or in an electronic or print directory listing.

Once prompted at block 112, the mobile device user 16,18,20 may then send the unique SMS text message code to the telephone number provided on the advertisement, as indicated generally at block 114. The request for more information can then be relayed to the content management server 14, as indicated generally at block 116. When this occurs, and as indicated further at block 118, the content management engine 32 may be configured to receive various parameters relating to the user's mobile device, including a unique number identifying the mobile device, the type of mobile device transmitting the request, the operating platform of the mobile device, and the wireless service provider hosting the mobile device. In some cases, additional information may be provided from the mobile device, including the user's name and address. If the mobile device is equipped with a GPS unit, the current location of the mobile device user may also be transmitted to the content management server 14.

At block 120, the content management engine 32 may then retrieve the requested advertisement information from the advertisement database 34. If the advertisement contains additional information supplied from a third-party entity, the engine 32 may further transmit a request to the entity to receive the additional information, as indicated generally at block 122. The data received from the advertisement database 34 and/or third party entity 40,42,44 can then be converted into a format suitable for display on the display screen of the user's mobile device, as indicated generally at block 124. If, for example, the mobile device has an operating system capable of displaying only still images on the display screen, the engine 32 can be configured to format the advertisement to match the display capabilities of the mobile device as well as that specified by the mobile device user's service provider. Conversely, if the user's mobile device is capable of displaying slideshows containing sequences of images, the engine 32 can be configured to feed a slideshow to the user's mobile device containing several images provided by the advertiser 24,26,28 and/or third-party entity 40,42,44.

Once the advertisement has been converted into a suitable format for display on the user's mobile device, the content management engine 32 may then transmit the advertisement to the user's mobile device, as indicated generally at block 124. The advertisement content can then be displayed on the device's display screen, as indicated generally at block 126, providing the user with the requested advertisement. Once viewed, the mobile device user 16,18,20 may then request additional information relating to the advertisement displayed on their display screen. The request for additional information can occur, for example, when the user 16,18,20 selects a hyperlink or E-mail address provided on the display screen.

If at decision block 128 the mobile device user 16,18,20 requests additional information, the content management server 14 may then transmit the additional information to the user's mobile device or provide the user with instructions on viewing the additional information, as indicated generally at block 130. In some cases, for example, the additional information may be provided to the mobile device user 16,18,20 via E-mail or through a link to a web-site hosted by the content management server 14.

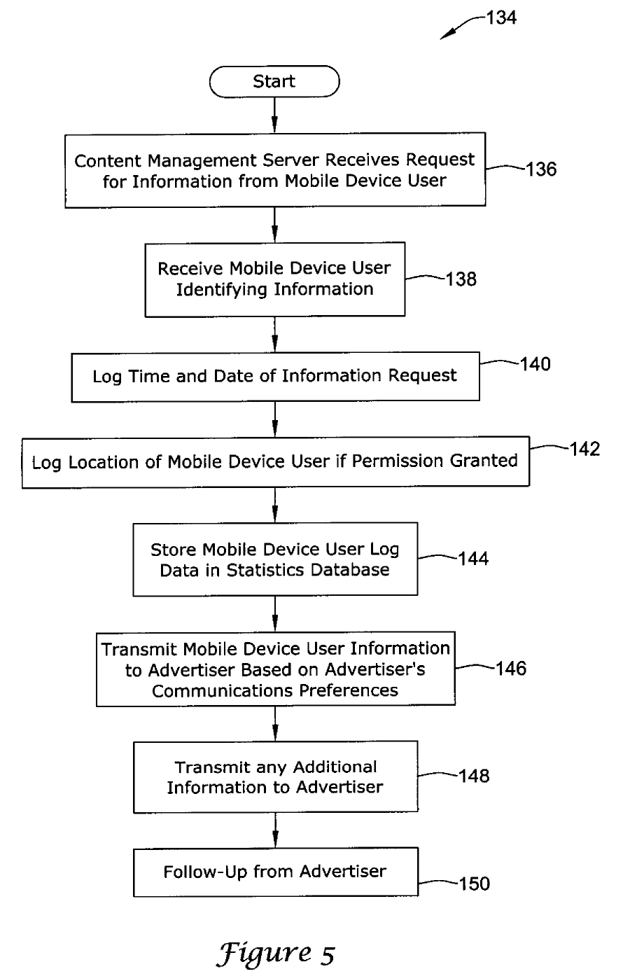

As the advertisement requests are received from each of the mobile device users 16,18,20, the content management server 14 may be configured to log information which can later be used to provide advertisers 24,26,28 and third-party entities 40,42,44 with information about the efficacy and return on investment (ROI) of a particular advertising campaign. An illustrative method 134 of collecting advertisement feedback from mobile device users 16,18,20 opting into the system 10 may be understood with respect to FIG. 5.

As shown in FIG. 5, the method 134 may begin generally at block 136, when the content management server 14 receives a request for information from a mobile device user 16,18,20. Once a request is received, the content management server 14 may be configured to receive unique identifying information from the mobile device user 16,18,20, which can later be used to track any subsequent requests for information made by the user 16,18,20, or to track any purchases made subsequent to viewing the advertisement. User identifying information that can be received may include, for example, the user's telephone number and/or a unique identification code associated with the user's mobile device. In some cases, other information may be voluntarily provided when a call is placed including the mobile device user's name, address, E-mail address, and physical mailing address.

As each call is received, the content management engine 32 may be configured to log the time and date of the call, as indicated generally at block 140. In some instances, and as further shown at block 142, the engine 32 can be further configured to receive the user's current location in those instances where the mobile device is equipped with a GPS unit, and where the user provides the content management server 14 with permission to view such information. At block 144, the logged information can then be stored in the statistics database 38, which can then be later viewed by the advertiser 24,26,28 to determine the number of hits the advertisement received, the identify of the users 16,18,20 viewing the advertisement, as well as other activity history and/or statistical information relating to the advertisement. Such information can be viewed, for example, via a web-site portal accessible to the advertiser 24,26,28 based on the advertiser's login and password information.

Depending on the advertiser's communications preferences, the content management server 14 may further transmit a call or message to the advertiser 24,26,28 informing the advertiser 24,26,28 that a mobile device user 16,18,20 has requested more information about the advertisement, as indicated generally at block 146. If the advertiser 24,26,28 prefers communications to be made via telephone at the time of the user request, the content management server 14 may then automatically generate a call to the advertiser's contact person providing the advertiser 24,26,28 with an automated message that the advertisement has been viewed. Alternatively, or in addition, an E-mail message may be generated and delivered to the contact person indicating that the advertisement has been viewed. The notification to the advertiser 24,26,28 may be provided instantly at the time the call or request is received from the mobile device user 16,18,20, or can be provided at other times such as once a day, once a week, once a month, and so forth.

If any additional information has been gathered from the mobile device user 16,18,20, the content management server 14 may also be configured to transmit this information to the advertiser 24,26,28, as indicated generally at block 148. For example, if the mobile device user 16,18,20 completes a pre-approval form for the purchase of an automobile advertised through the system 10, the content management server 14 can be configured to transmit this information along with the other information received from the mobile device user 16,18,20. The advertiser 24,26,28 may then follow-up with the lead, as indicated generally at block 150.

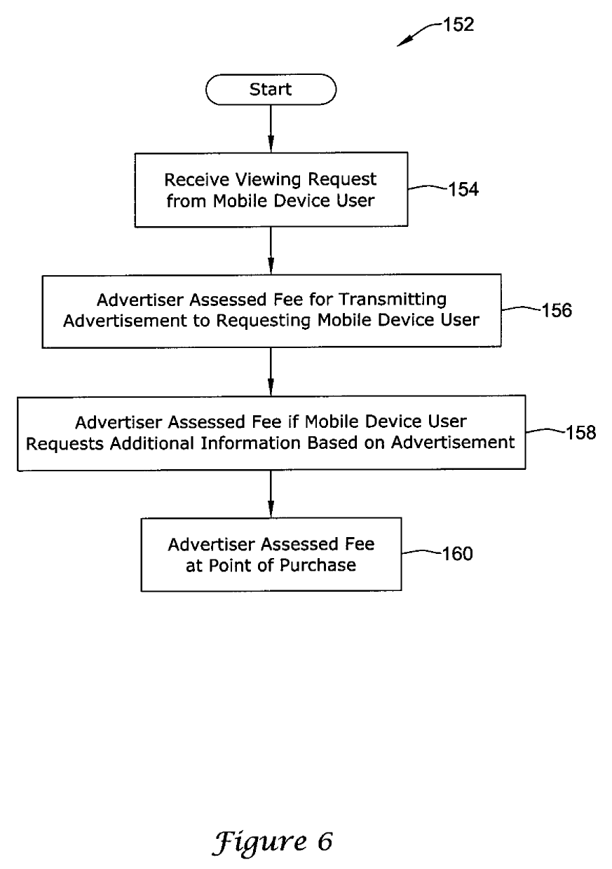

FIG. 6 is a flow diagram showing an illustrative method 152 of billing an advertiser 24,26,28 for advertisements placed on the content management server 14 of FIG. 1. The method may begin generally at block 154, when the content management server 14 receives a viewing request from a mobile device user 16,18,20. As each viewing request is received, and as indicated generally at block 156, the administrator 50 may then assess a fee for transmitting the requested advertisement to the user 16,18,20. In some instances, for example, the advertiser 24,26,28 may be assessed a per-hit or per-impression fee for providing the advertisement to the user 16,18,20, or may charge the advertiser 24,26,28 a flat fee for each day, week, month, etc. that the advertisement remains in effect.

If at block 158 the mobile device user 16,18,20 requests additional information based on the viewed advertisement, the administrator 50 may further assess the advertiser 24,26,28 another fee for the additionally viewed information. If, for example, the mobile device user 16,18,20 selects a hyperlink on the advertisement linking the user 16,18,20 to a web-site for more information about the product or service, the administrator 50 can be configured to assess the advertiser 24,26,28 with a second charge as the user 16,18,20 is redirected to the web-site to view the additional content. Any additional information received from a third-party entity 40,42,44 may also generate a fee to the advertiser 24,26,28 or, in some eases, to the mobile device user 16,18,20 at this step.

In certain instances, the advertiser 24,26,28 may be further assessed a fee at the point of purchase of the good or service, as indicated generally at block 160. If, for example, an electronic coupon or rebate is provided to the mobile device user 16,18,20 as an incentive to purchase the product through the advertiser 24,26,28, the administrator 50 may then assess the advertiser 24,26,28 with an additional fee as the coupon or rebate is redeemed by the user 16,18,20 at the point of purchase. At this stage, other information useful to the advertiser 24,26,28 may also be collected, including the user's personal information as well as individual's demographical information.

The fee schedule may be graduated such that initial requests to view an advertisement are assessed only a small fee whereas follow up requests and/or point-of-purchases are assessed at a higher fee based on the likely increase in rate of return on the advertisement. If additional information is gathered from a third-party entity 40,42,44, the administrator 50 may further assess the advertiser 24,26,28 with a fee to obtain such information from the third-party entity 40,42,44.

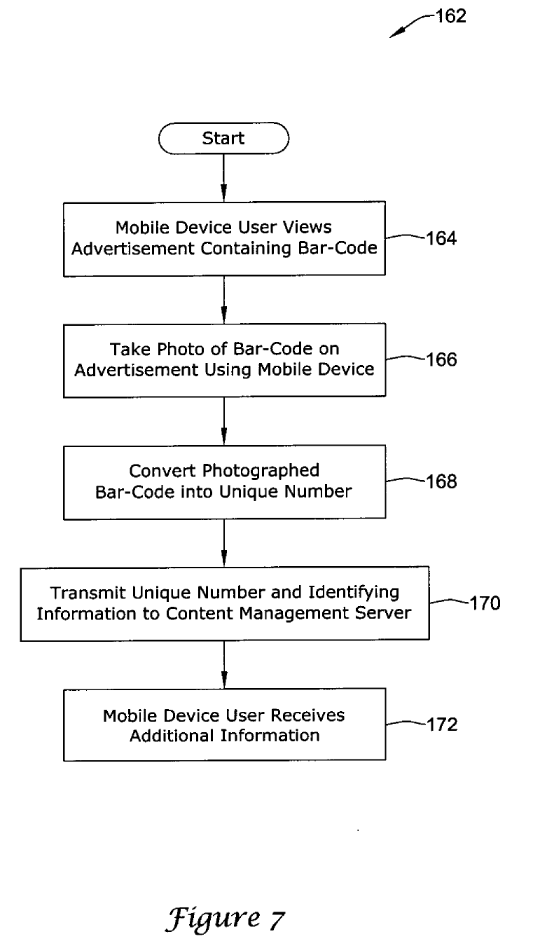

FIG. 7 is a flow diagram showing an illustrative method 162 of requesting advertising information using a mobile device equipped with an automatic bar-code reader. The method may begin generally at block 164, when the mobile device user 16,18,20 views and advertisement containing a unique bar-code associated with the advertised product or service. Once the mobile device user 16,18,20 views the advertisement, the user may then take a photograph of the bar-code with the mobile device, as indicated generally at block 166. The mobile device can then be configured to convert the photographed bar-code into a unique number (block 168), which can then be transmitted (block 170) along with the user's identifying information to the content management server 14 requesting that the selected advertisement be delivered to the user's mobile device.

Once submitted, the content management server 14 can be configured to transmit the addition information requested to the user's mobile device, as indicated generally at block 172. The additional information can then be displayed on the user's display screen. If, at block 172, the mobile device user 16,18,20 receives any electronic coupons, rebates, or other such incentives from the advertiser, the user 16,18,20 may then submit the incentive at the point of purchase. For example, if an electronic coupon containing a bar-code is provided to the mobile device user 16,18,20 at step 172, the bar-code may be displayed on the user's display screen allowing it to be scanned and redeemed at the point of purchase.

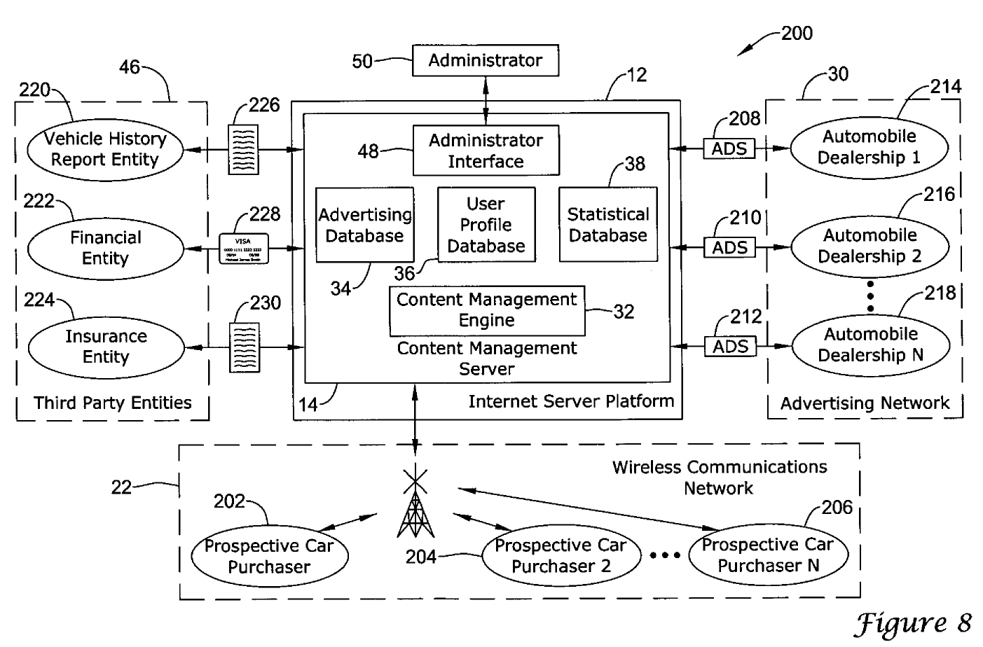

Referring now to FIG. 8, an illustrative system 200 for providing direct-to-user advertising and information services for a number of automobile dealerships will now be described. As shown in FIG. 8, the system 200 may include one or more prospective car purchasers 202,204,206 each having a mobile device operating on a wireless communications network 22. The prospective car purchasers 202,204,206 may each include a mobile device capable of receiving advertisements 208,210,212 from one or more automobile dealerships 214,216,218 within the advertising network 30. The advertisements 208,210,212 may be created, for example, in a manner similar to that described above with respect to FIGS. 2A-2B, by prompting the automobile dealerships 214,216,218 to fill in several fields vis-à-vis a web-based advertisement program. The advertisements 208,210,212 may be created in other ways, however, either electronically or by paper. For example, the advertisements 208,210,212 may be created by the advertiser 214,216,218 filling out a form and submitting the form to the administrator 50, which then creates the advertisement content and layout.

In some instances, the content management server 14 may be further linked electronically to one or more third-party entities 220,222,224 that can be used to provide additional information to the prospective car purchasers 202,204,206. In FIG. 8, for example, a vehicle history report entity 220 such as CARFAX 202 may be utilized to provide a vehicle report 226 of the advertised vehicle to prospective car purchasers 202,204,206 requesting such information. If after a prospective car purchaser 202,204,206 receives an advertisement 208,210,212 for a particular automobile but desires further information on the vehicle's title and accident history, the prospective purchaser 202,204,206 may submit a request to the content management server 14 requesting such information be provided directly to their mobile device, E-mail address, and/or to a web-site address hosted by the content management server 14.

Other third-party entities may be used to provide other informational services to the prospective car purchasers 202,204,206 as well as to the advertisers 214,216,218. A financing entity 222, for example, can be configured to provide pre-approval to the prospective car purchasers 202,204,206 for financing the advertised vehicle. In some cases, for example, the financing entity 222 may send a short pre-approval form 228 to the content management server 14, which can then be converted electronically into a format suited for the prospective car purchaser's 202,204,206 mobile device. The pre-approval form can then be transmitted to the prospective car purchaser's mobile device, completed, and submitted back to the financing entity 222 via the server 14. The status of the pre-approval process (e.g. “accepted”, “denied”, etc.) can then be delivered to the automobile dealership 214,216,218 indicating whether the prospective car purchaser 202,204,206 is financially capable of purchasing the vehicle.

An insurance entity 224 can be used to provide the prospective car purchaser 202,204,206 with insurance information 230 about the costs associated with insuring the advertised vehicle. If, for example, the prospective car purchaser 202,204,206 desires to learn more about the costs of insuring a particular vehicle, the purchaser 202,204,206 may transmit a request to the content management server 14 requesting that an insurance agent contact the purchaser 202,204,206 on their mobile device. In some cases, the insurance entity 224 may provide the purchaser 202,204,206 with an instant message or E-mail message indicating the costs associated with insuring the vehicle along with the name and telephone number of an insurance agent that can be contacted for providing such insurance.

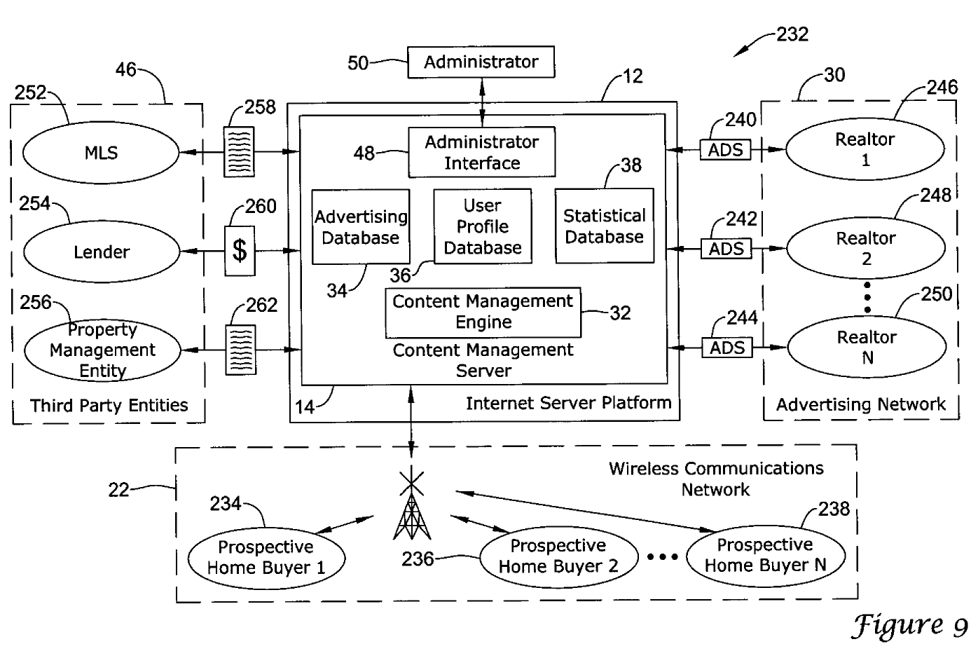

FIG. 9 is a diagrammatic view showing an illustrative system 232 for providing direct-to-user advertising and information services for a number of real estate agents. As shown in FIG. 9, the system 232 may include one or more prospective home buyers 234,236,238 each having mobile device operating on a wireless communications network 22. The prospective home buyers 234,236,238 can each receive advertisements 240,242,244 from one or more realtors 246,248,250 within the advertising network 30. The advertisements 240,242,246 may be created, for example, in a manner similar to that described with respect to FIGS. 2A-2B, by prompting the realtors 246,248,250 to fill in several fields vis-à-vis a web-based advertisement program. In addition, or in lieu, the advertisements 240,242,246 may be generated automatically by the advertisement program from data contained within an MLS database, the advertiser's own database, and/or from some other database source.

In some instances, the content management server 14 can be further linked electronically to one or more third-party entities 252,254,256 that can be used to provide additional information to the prospective home buyers 234,236,238. In FIG. 9, for example, a multiple listing service (MLS) database 252 can provide an MLS report 258 on an advertised home to prospective home buyers 234,236,238 requesting such information. If, for example, the prospective home buyer 234,236,238 desires updated information on the listing that is not contained on the initial advertisement sent to the prospective home buyer's mobile device, the buyer may submit a request to the content management server 14 through their mobile device requesting such information be provided directly to their mobile device, E-mail address, and/or a web-site address, as desired.

A lender 254 may be integrated into the system 232, allowing a pre-approval form 260 to be provided to the prospective home buyer's 234,236,238 mobile device upon request. If after viewing an advertisement, for example, the prospective home buyer 234,236,238 desires to complete a pre-approval form to determine eligibility for purchasing the advertised home, the lender 254 may send a short pre-approval form 258 to the content management server 14, which can then be converted electronically into a format suited for display on the prospective home buyer's 234,236,238 mobile device. The pre-approval form can then be transmitted to the prospective home buyer's 234,236,238 mobile device, completed, and submitted back to the lender 254 via the server 14. A pre-approval letter can then be generated and delivered to the realtor 246,248,250 hosting the requested advertisement. In those instances where the advertised property is investment property, other information such as a list of pre-certified property managers 262 may also be provided to the prospective home buyer 234,236,238 from a property management entity 256.

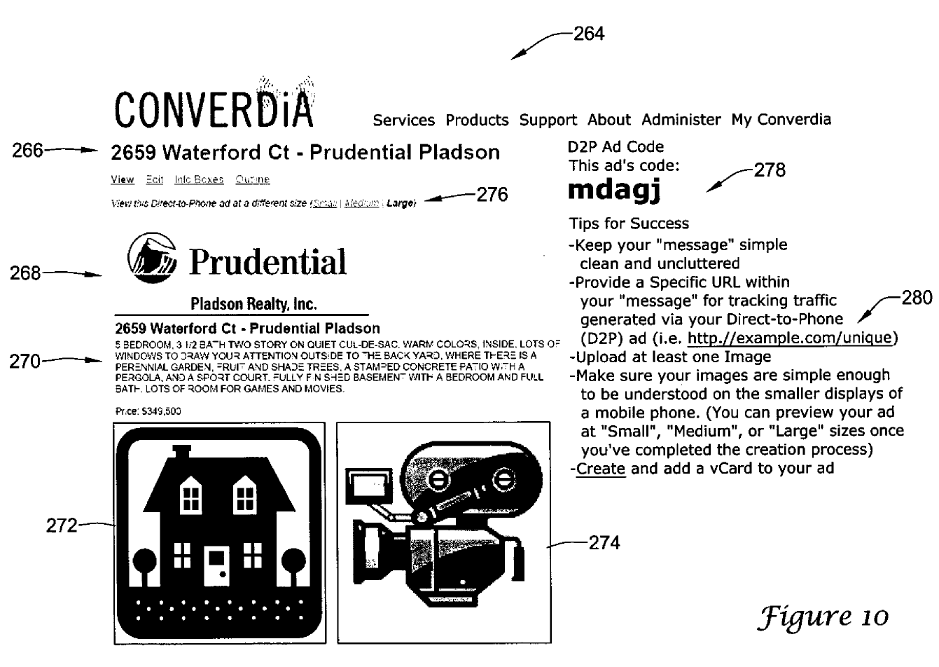

FIG. 10 is a screen-shot showing an illustrative housing advertisement 264 that can be created and delivered to a prospective home buyer using the content management server 14 of FIG. 9. The screen-shot may represent, for example, the display screen that an advertiser views upon creating an advertisement and publishing the advertisement to an on-line database available over the Internet. As shown in FIG. 10, the advertisement 264 can include a title 266 identifying the advertised property, a logo 268 identifying the listing agent, and a brief description 270 of the property listing the amenities of the property and the asking price.

If desired, other information about the advertised property may also be provided such as the annual property taxes assessed against the property, the school district in which the property is located, and the demographics of the surrounding neighborhood. In those instances where the mobile device is capable of displaying graphics, a number of still images, streaming video, and/or featured graphics 272,274 may be provided on the advertisement 264, if desired. Image 272 may represent, for example, a still image of the exterior of the advertised home whereas image 274 may be a 360° moving picture showing the interior of the home. The size of the displayed advertisement, including the rendering of the still images and/or graphics 272,274, may be adjusted via a toolbar 276 on the display screen.

The advertisement 264 may further include a unique identification code 278 which can be used by prospective home buyers to request that the advertisement be sent electronically to their mobile device. In some instances, for example, the unique identification code 278 may comprise a five-digit SMS text message code (e.g. “mdagj”) that can be entered by a prospective home buyer in order to receive the advertisement 264 electronically on their mobile device. A help section 280 of the advertisement 264 may be used to provide the advertiser with guidance on creating advertisements, if desired.

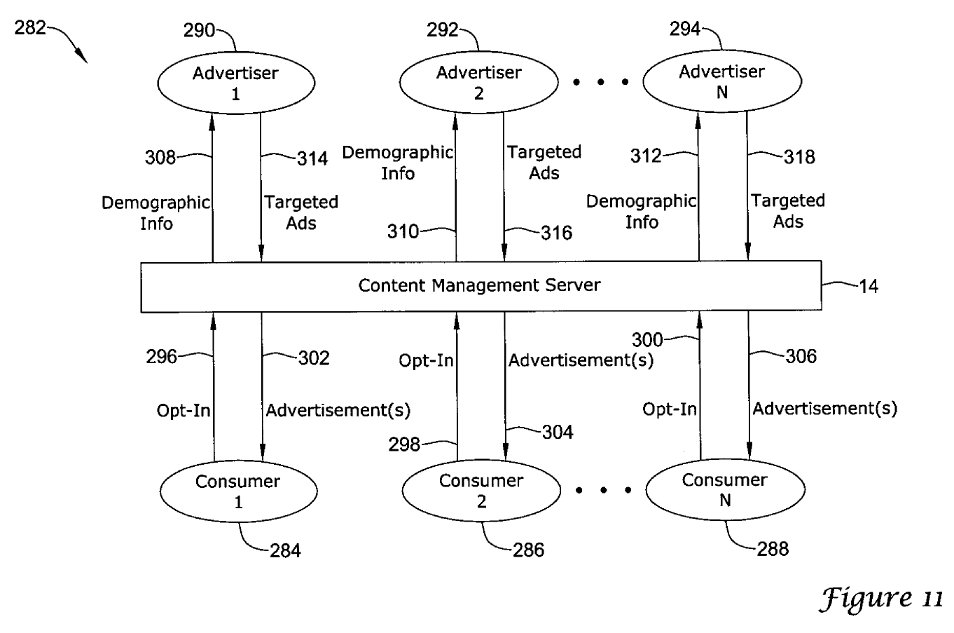

FIG. 11 is a diagrammatic view of another illustrative system 282 for providing advertising information to one or more consumers within a network. As shown in FIG. 11, the system 282 can include a number of consumers 284,286,288 each in communication with the content management server 14. For example, one or more of the consumers 284,286,288 may be in communication with the server 14 wirelessly through a mobile device such as a cellular telephone, PDA, a BLUETOOTH equipped device, or a laptop computer. In some instances, one or more of the consumers 284,286,288 may be in communication with the server 14 through an Internet connection. Other means for communicating back and forth between the consumers 284,286,288 and the content management server 14 may also used, if desired.

The content management server 14 may also be in communication with one or more advertisers 290,292,294 desiring to provide targeted advertisements to selective consumers 284,286,288 based on the consumer's buying behavior, demographics, place of residence, as well as other factors. An example advertiser 290,292,294 may be a fast-food retailer that wishes to deliver targeted advertisements to a particular market segment based on the demographics associated with that segment.

As indicated generally by arrows 296,298,300 in FIG. 11, one or more of the consumers 284,286,288 may opt into to the system 282 in order to receive advertisements 302,304,306 from one or more of the advertisers 290,292,294 within the system 282. In some instances, for example, the consumers 284,286,288 may opt into to the system 282 by completing an on-line enrollment form containing the consumer's name, address, mobile telephone number, home telephone number, and E-mail address. The consumer 284,286,288 may also opt into to the system 282 by sending a text message to the content management server 14, similar to that described above with respect to FIGS. 4A-4B.

In some cases, demographic information about the consumer 284,286,288 can also be collected, including the consumer's age, gender, ethnicity, income, employment status, job title, marital status, and number of children. The consumer 284,286,288 may also be prompted to provide other personal information such as the consumer's hobbies and interests.

The information collected by the content management server 14, including the demographic information provided when the consumers 284,286,288 opt into the system 282, may be transmitted to one or more of the advertisers 290,292,294 requesting such information. As indicated generally by arrows 308,310,312 in FIG. 11, each advertiser 290,292,294 can receive demographic information for each consumer 284,286,288 within the system 284, which can then be utilized by the advertiser 290,292,294 to generate targeted advertisements 314,316,318 for delivery to certain consumers 284,286,288. For example, a fast-food retailer may request a list of consumers that fall within a particular age range and which have children. From this information, the fast-food retailer may then send a targeted advertisement or advertisements to those consumers within the system 282 that meet the fast-food retailer's advertising criteria.

To provide an incentive for consumers 284,286,288 to opt into to the system 282, a rebate, credit, coupon or other form of remuneration may be provided to the consumer 284,286,288 for each advertisement that is viewed. The amount of remuneration provided to the consumers 284,286,288 can be conditioned upon the consumer 284,286,288 viewing the advertisement and/or can be conditioned based on the consumer 284,286,288 viewing a certain number of advertisements weekly, monthly, yearly, or other such time period. In some cases, the costs associated with paying consumers 284,286,288 who opt into to the system 282 can be assessed against those advertisers 290,292,294 providing the advertising content to the consumer.

In some cases, a certain percentage (e.g. 5%, 10%, 25%, etc.) of the revenue generated from the advertisements can be provided to each consumer 284,286,288 as an incentive for opting into the system 282. For example, a consumer 284,286,288 may be given a rebate, credit, coupon, cash-back or other form of remuneration for viewing the advertisement 302,304,306, which can then later be redeemed at the point of purchase.

As a further incentive to purchase the advertised product or service directly from the advertiser 290,292,294, the percentage received by the consumer 284,286,288 may be increased if the consumer 284,286,288 purchases the advertised product or service directly through the advertiser 290,292,294 or an agent of the advertiser 290,292,294. For example, a 25% rebate received from the advertiser 290,292,294 may be increased to 50% in the event the consumer 284,286,286 purchases the product or service via an on-line marketplace such as AMAZON.COM, directly from the advertiser's 290,292,294 own web-site, in-store from one of the advertiser's stores, etc. The percentage and/or form of remuneration provided to the consumer 284,286,288 may vary depending on the type of product or service advertised, the manner in which the remuneration is received, as well as other factors.

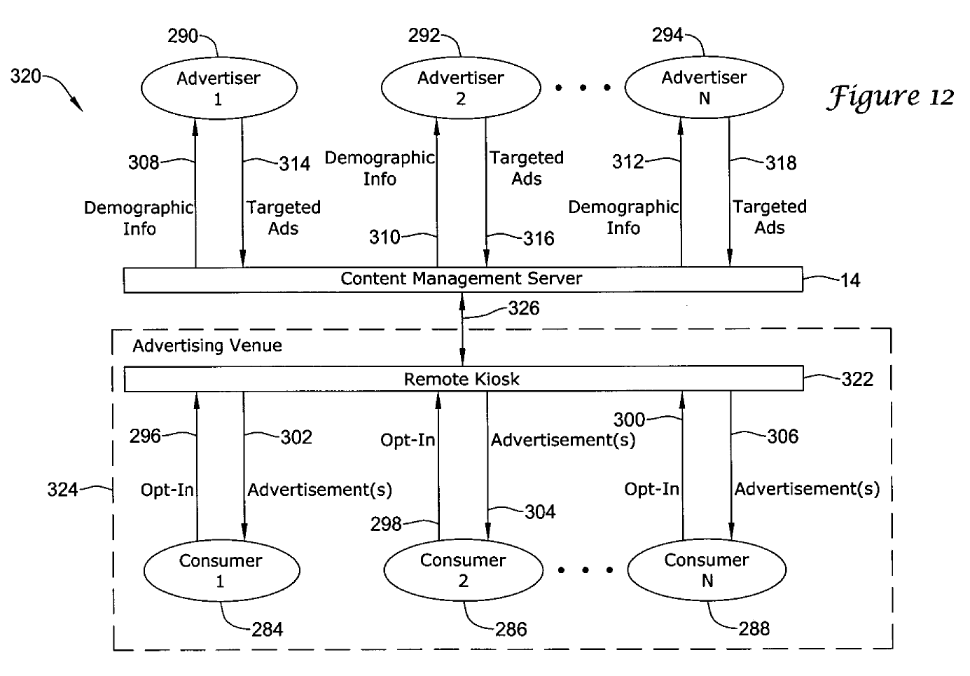

FIG. 12 is a diagrammatic view showing another illustrative system 320 for providing advertising information to one or more consumers within a particular advertising venue. The system 320 may be similar to that described above with respect to FIG. 11, with like elements labeled in like fashion in the drawings. In FIG. 12, however, a remote kiosk 322 may be provided at an advertising venue 324 which can be configured to send a signal to the mobile device of each consumer 284,286,288 within a certain range of the kiosk 322.

The remote kiosk 322 may include, for example, a wireless device located within a retail store or shopping mall capable of detecting and transmitting signals to the mobile devices of any consumers 284,286,288 located within the store or mall, or within a certain distance from the store or mall. As indicated generally by arrow 326, the remote kiosk 322 may provide a single, secure communications conduit between the consumers 284,286,288 and the content management server 14.

The remote kiosk 322 may be configured to transmit an invitation request to the mobile device of each consumer 284,286,288 within the advertising venue 324, inviting the consumers 284,286,288 to opt into the system 320. The invitation may occur, for example, by sending a text message to the consumer's mobile device via a BLUETOOTH connection. If the consumer 284,286,286 does not have a BLUETOOTH enabled device, the remote kiosk 322 can be configured to deliver an invitation to the consumer 284,286,288 to view the same advertisement information by sending a text message directly to the server 14, or by visiting a web-site hosted by the server 14.

Once the consumer 284,286,288 receives an invitation, the consumer 284,286,288 may then opt into the system 320 and receive advertisements and incentives in a manner similar to that discussed herein. Alternatively, if the consumer 284,286,288 does not desire to receive advertisements, the consumer 284,286,288 may opt out at the time of the invitation. If the consumer 284,286,288 opts out of the system 320, the content management sever 14 can be configured to place that consumer 284,286,288 on a do-not-call list to prevent the server 14 from initiating further contact with the consumer 284,286,288.

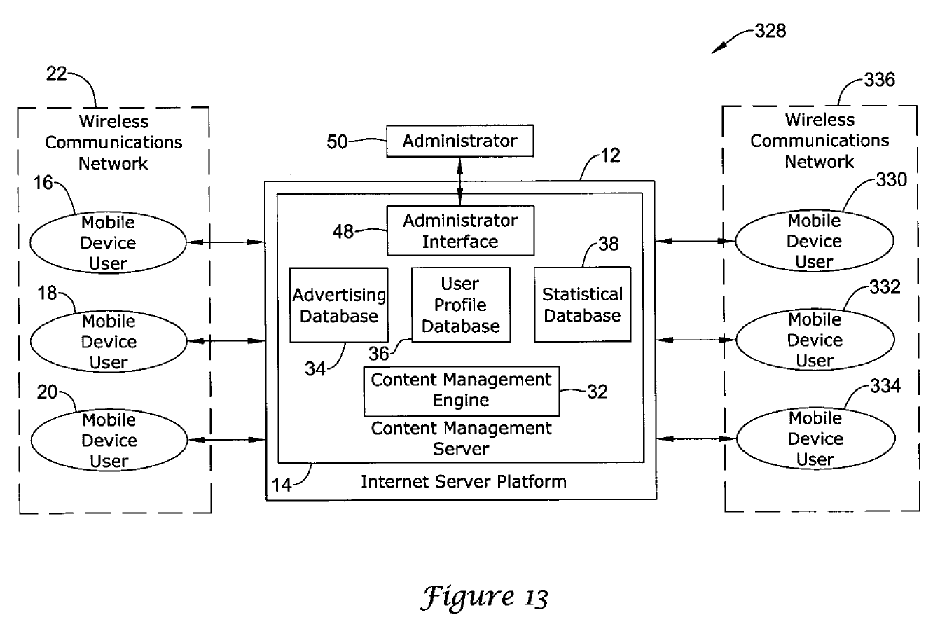

FIG. 13 is a diagrammatic view showing another illustrative system 328 for providing user-to-user media and information exchange services among mobile device users. As shown in FIG. 13, the system 328 may include one or more mobile device users 16,18,20 that have opted into the system 328 and one or more mobile device users 330,332,334 on a wireless communications network 336 in which the mobile device users 16,18,20 desire to share media and other information with. The mobile device users 328,330,332 may represent, for example, friends or family members of the mobile device users 16,18,20 who may or may not have opted into the system 328, and who may benefit from receiving information requested by the mobile device users 16,18,20 that have opted into the system 328.

If one or more of the mobile device users 16,18,20 desire to share information with one or more of the other mobile device users within the other network 336, the mobile device user 16,18,20 may transmit a signal via the wireless communications network 22 to the content management server 14 requesting that the information be shared. Once a request is received by the server 14, the content management engine 32 can be configured to prompt the mobile device user 16,18,20 to change and/or add additional information to the content to be submitted, if desired. If the mobile device user 16,18,20 desires to share an automobile advertisement with another mobile device user 330,332,334, for example, the content management engine 32 may prompt that individual to submit other information about the advertisement such as a text message indicating the condition of the vehicle.

Once the options for altering the media and information have been selected by the mobile device user 16,18,20, the content management server 14 may prompt the mobile device user 16,18,20 to select one or more mobile device users 330,332,334 that they wish to share the media and information with. Once selected, the content management engine 32 can be configured to find the users within the user profile database 36, collects and implements the contact information, and then transmits the modified media and information to those mobile device users 330,332,334 selected by the mobile device user 16,18,20. The modified media and information can be transmitted, for example, to the mobile device user's cellular phone or personal digital assistant (PDA) and/or to the user's E-mail address via the Internet sever platform 14. Other means for transmitting the media and information is possible, however.

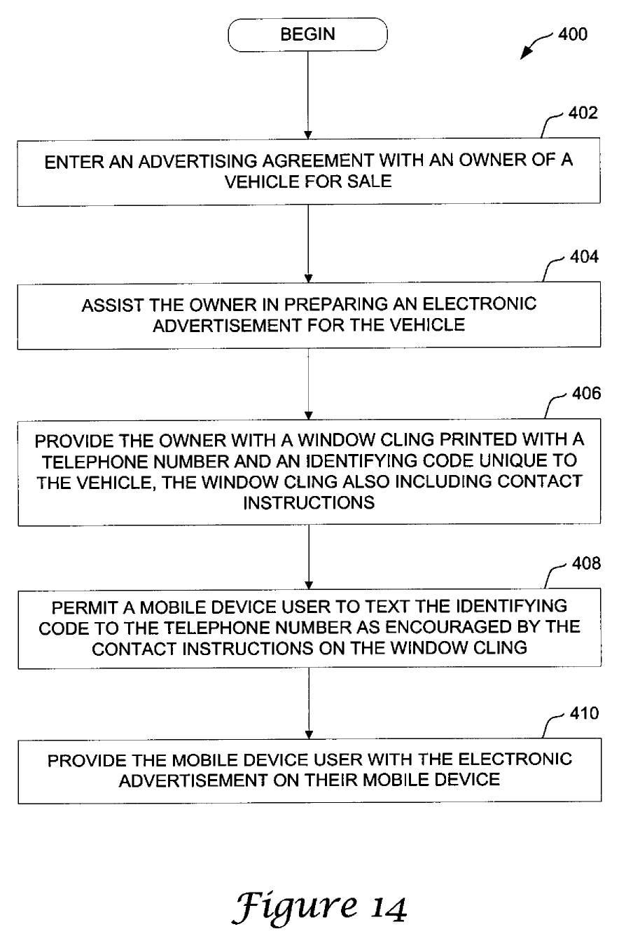

FIGS. 14 through 21 provide flow diagrams of illustrative methods that may be carried out using the illustrative system 10. FIG. 14 shows a method 400 that may generally begin at block 402, where an advertising agreement may be reached with an owner of a vehicle for sale. In some instances, content management server 14 may electronically form an advertising agreement with the vehicle owner. In some cases, the administrator 50 may form the advertising agreement and may provide the details of the agreement to the content manager server 14 through the administrator interface 48.

In some cases, the vehicle may be an automobile, but this is not required. In some cases, the vehicle may be a boat, an all-terrain vehicle, a recreational vehicle, and the like. The vehicle owner may be an individual who has a single automobile to sell. In some instances, the vehicle owner may instead be a corporate or other legal entity that owns a number of vehicles they wish to sell. For example, the vehicle owner may represent an automobile dealer.

At block 404, the vehicle owner may be assisted in preparing the electronic advertisement. In some instances, assisting the owner in preparing an electronic advertisement for the vehicle may include providing step-by-step directions, via a website, to enter information for one or more distinct categories of information that may be provided within an electronic advertisement. In some cases, assisting the owner in preparing an electronic advertisement for the vehicle may also include permitting the owner to associate information from a third-party entity with the electronic advertisement. In some cases, this may be accomplished as discussed previously with respect to FIGS. 2A and 2B, although other methods are also contemplated.

At block 406, the vehicle owner is provided with a window cling that is printed with a telephone number and an identifying code (short code) that is unique to the vehicle. The window cling may also provide contact information that instructs and/or encourages a mobile device user 16,18,20 to text the identifying code to the telephone number, as shown generally at block 408. In some instances, dialing the telephone number provides the mobile device user 16,18,20 with access to a web-based content management server that is adapted to transmit advertisements and other informational content on-demand to the mobile device user, such as the content management server 14.

The content management server 14 may, in response, provide the mobile device user with an electronic advertisement corresponding to the identifying code as shown generally at block 410. It will be appreciated that the mobile device user 16,18,20 may receive a formatted electronic advertisement as previously discussed herein. In some instances, the electronic advertisement may be customized based at least in part on the browser capabilities of the mobile device.

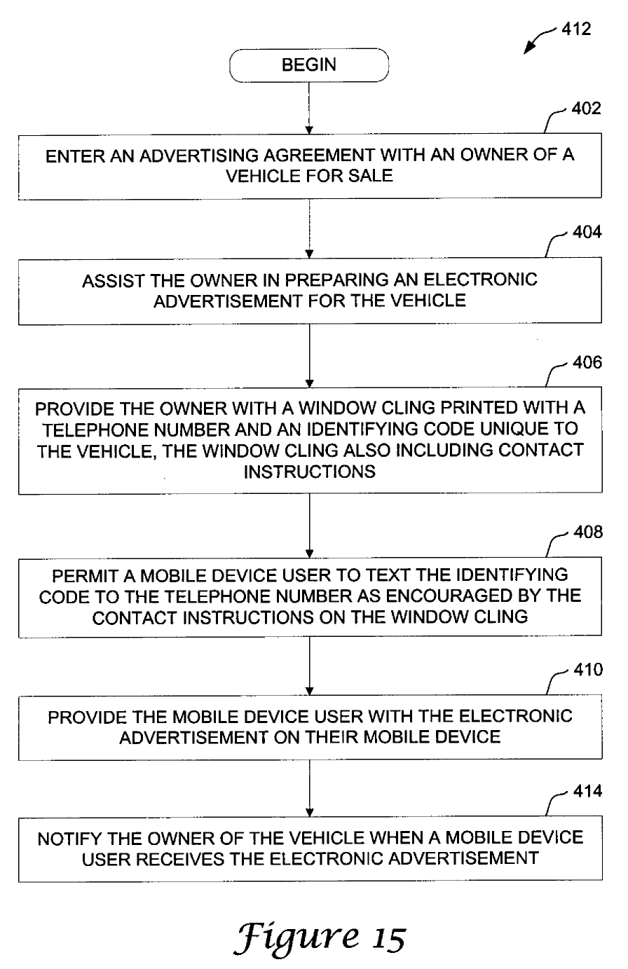

FIG. 15 shows a method 412 that is similar to method 400 (FIG. 14), but adds an additional step. Method 412 generally begins at block 402, where an advertising agreement may be reached with an owner of a vehicle for sale, as discussed previously. At block 404, the vehicle owner may be assisted in preparing the electronic advertisement. In some cases, this may be accomplished as discussed previously with respect to FIGS. 2A and 2B, although other methods are also contemplated.

At block 406, the vehicle owner is provided with a window cling that is printed with a telephone number and an identifying code that is unique to the vehicle. The window cling may also provide contact information that instructs and/or encourages a mobile device user to text the identifying code to the telephone number, as shown generally at block 408. The content management server 14 may, in response, provide the mobile device user 16, 18,20 with an electronic advertisement corresponding to the identifying code as shown generally at block 410.

At block 414, the content management server 14 may notify the owner of the vehicle that the mobile device user 16,18,20 has received an electronic advertisements as shown generally at block 414. As discussed previously, the content management server 14 may collect information pertaining to viewing history and the like, and may provide such information to the vehicle owner.

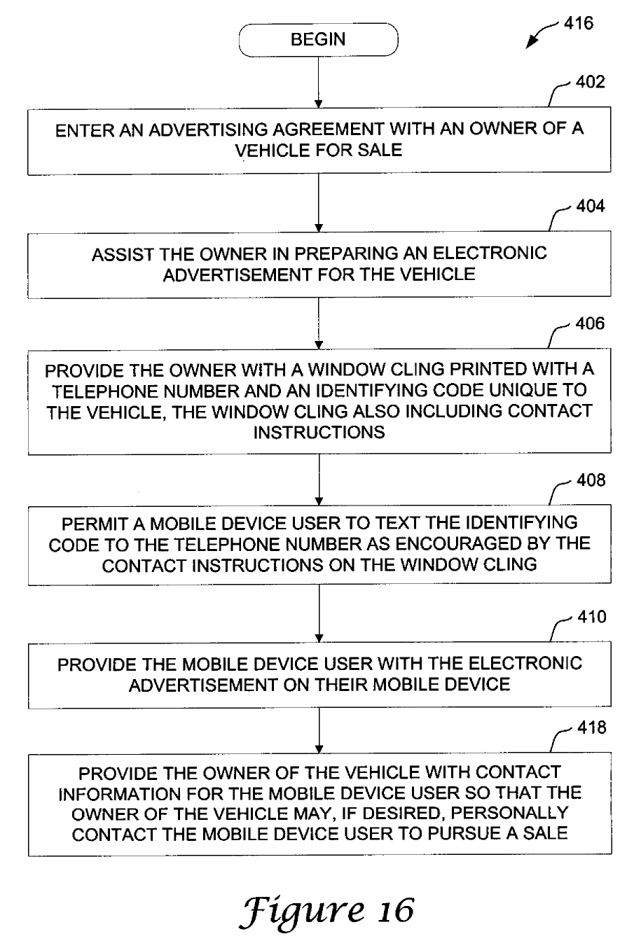

FIG. 16 shows a method 416 that is similar to method 400 (FIG. 14), but adds an additional step. Method 416 generally begins at block 402, where an advertising agreement may be reached with an owner of a vehicle for sale, as discussed previously. At block 404, the vehicle owner may be assisted in preparing the electronic advertisement. In some cases, this may be accomplished as discussed previously with respect to FIGS. 2A and 2B, although other methods are also contemplated.

At block 406, the vehicle owner is provided with a window cling that is printed with a telephone number and an identifying code that is unique to the vehicle. The window cling may also provide contact information that instructs and/or encourages a mobile device user to text the identifying code to the telephone number, as shown generally at block 408. The content management server 14 may, in response, provide the mobile device user 16,18,20 with an electronic advertisement corresponding to the identifying code as shown generally at block 410.

At block 418, the content management server 14 may provide the owner of the vehicle with contact information for the mobile device user 16,18,20 so that the vehicle owner may, if desired, directly contact the mobile device user 16,18,20 in order to follow up with the mobile device user 16,18,20 and further pursue the sale. As noted above, the content management server 14 may compile user information.

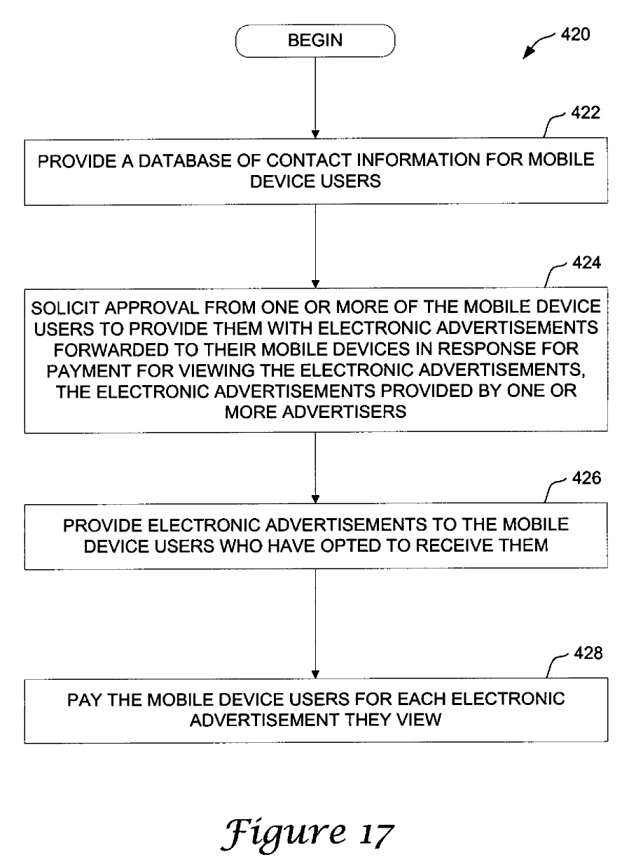

FIG. 17 shows an illustrative method 420 of increasing advertisement effectiveness that begins generally at block 422. At block 422, a database is provided that includes contact information for mobile device users 16,18,20. In some cases, the database may be compiled by the content management sever 14.

At block 424, one or more of the mobile device users 16,18,20 may be contacted in order to solicit approval from the mobile device users 16,18,20 to provide them with electronic advertisements (on their mobile devices) in exchange for receiving payment for viewing the electronic advertisements. The electronic advertisements may be provided by one or more advertisers. In some cases, the mobile device users 16,18,20 may be contacted via text message or any other suitable contact method.

In some instances, part of the process for soliciting approval includes obtaining demographic information from the mobile device users. A web-based content management server such as content management server 14 may determine, based on the demographic information and any criteria provided by the one or more advertisers, which electronic advertisements to provide to a particular mobile device user. In some instances, approval is given to forward the demographic information to the advertisers, and the advertisers determine, in response, which mobile device users 16,18,20 will receive particular electronic advertisements.

At block 426, the content management server 14 provides electronic advertisements to the mobile device users 16,18,20 who have elected to participate. At block 428, the mobile device users 16,18,20 are reimbursed in accordance with the number of electronic advertisements they have viewed. In some cases, the mobile device users 16,18,20 are paid more if they buy directly from the one or more advertisers providing each electronic advertisement.

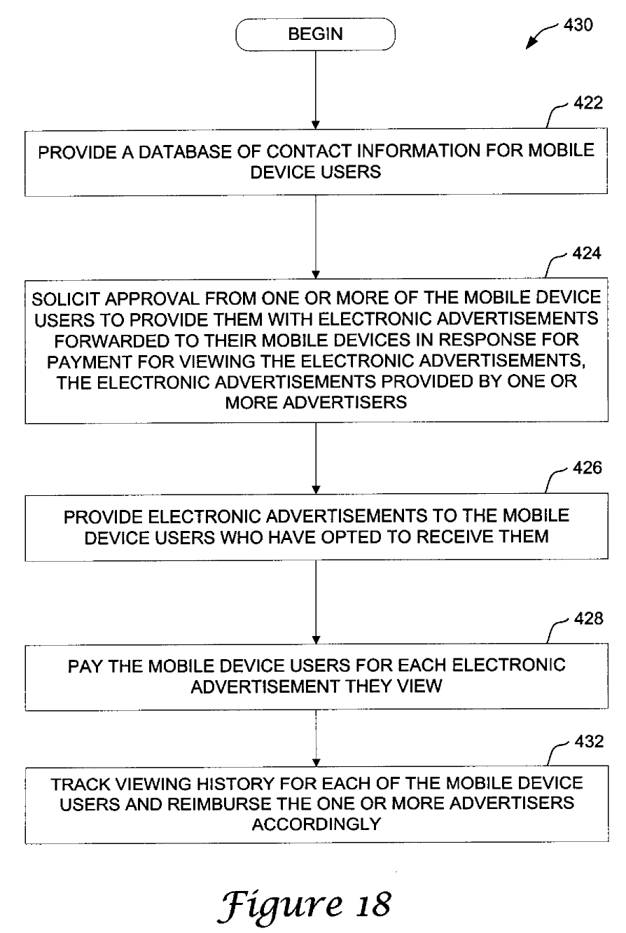

FIG. 18 shows an illustrative method 430 that is similar to method 420, but adds an additional step. Method 430 begins generally at block 422. At block 422, a database is provided that includes contact information for mobile device users 16,18,20. In some cases, the database may be compiled by the content management sever 14.

At block 424, one or more of the mobile device users 16,18,20 may be contacted in order to solicit approval from the mobile device users 16,18,20 to provide them with electronic advertisements (on their mobile devices) in exchange for receiving payment for viewing the electronic advertisements. The electronic advertisements may be provided by one or more advertisers. At block 426, the content management server 14 provides electronic advertisements to the mobile device users 16,18,20 who have elected to participate. At block 428, the mobile device users 16,18,20 are reimbursed in accordance with the number of electronic advertisements they have viewed. At shown at block 432, the content management server 14 may track viewing history for each of the mobile device users 16,18,20 and may reimburse the advertisers accordingly.

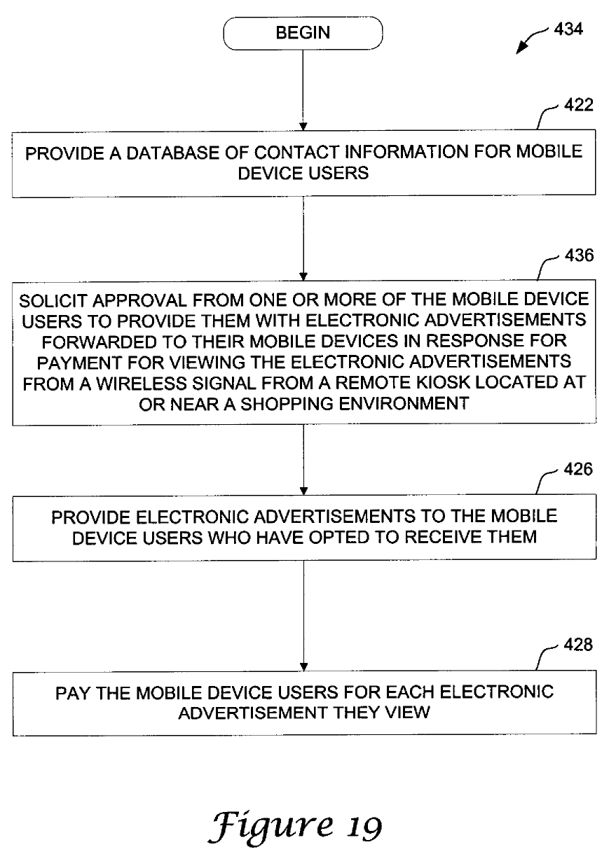

FIG. 19 shows an illustrative method 434 of increasing advertisement effectiveness that begins generally at block 422. At block 422, a database is provided that includes contact information for mobile device users 16,18,20. In some cases, the database may be compiled by the content management sever 14.

At block 436, one or more of the mobile device users 16,18,20 may be contacted in order to solicit approval from the mobile device users 16,18,20 to provide them with electronic advertisements (on their mobile devices) in exchange for receiving payment for viewing the electronic advertisements. The electronic advertisements may be provided by one or more advertisers.

In some cases, the mobile device users 16,18,20 may be contacted via a wireless signal from a remote kiosk that may be located at or near a shopping environment such as a store, a shopping mall, and the like. In some instances, the remote kiosk may be in communication with a web-based content management server such as content management server 14.

At block 426, the content management server 14 provides electronic advertisements to the mobile device users 16,18,20 who have elected to participate. At block 428, the mobile device users 16,18,20 are reimbursed in accordance with the number of electronic advertisements they have viewed.

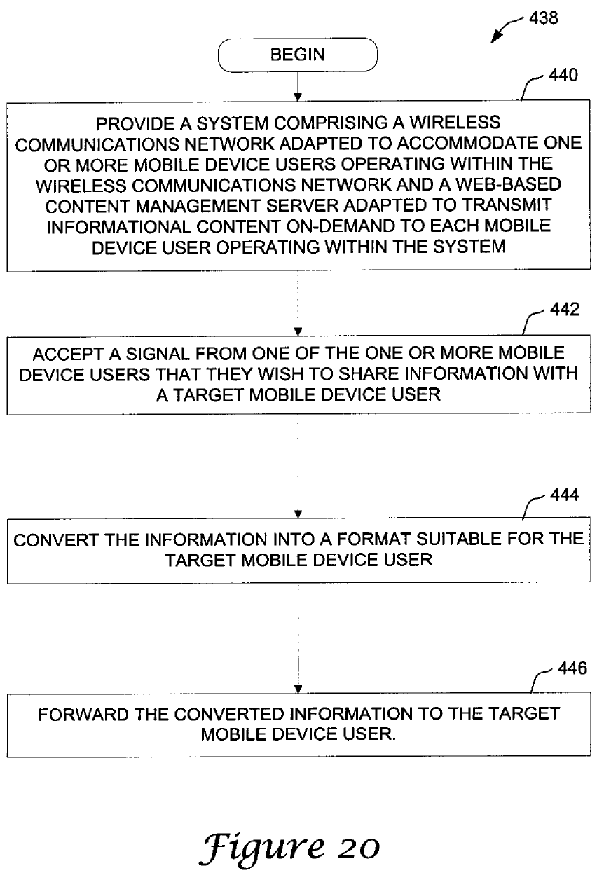

FIG. 20 shows an illustrative method 438 of providing user-to-user information exchange services. The method 438 begins generally at block 440, which describes a step of providing a system 328 that includes a wireless communications network that is adapted to accommodate one or more mobile device users 16,18,20 operating within the wireless communications network and a web-based content management server that is adapted to transmit informational content on-demand to each mobile device user 16,18,20 operating within the system.

At block 442, a signal may be accepted from one of the one or more mobile device users 16,18,20 that they wish to share information with a target mobile device user 330,332,334. In some instances, this signal may be received by content management server 14. In some cases, the information that the mobile device user 16,18,20 wishes to share may be an electronic advertisement that the mobile device user 16,18,20 received on their mobile device. In some instances, the target mobile device user 330,332,334 may be within the wireless communications network 22 that the mobile device user 16,18,20 is in. In some cases, the target mobile device user 330,332,334 may not be within the wireless communications network 22.

Content management server 14 may convert the information into a format that is suitable for the target mobile device user 330,332,334, as shown generally at block 444. At block 446, the content management server 14 may forward the converted information to the target mobile device user 330,332,334.

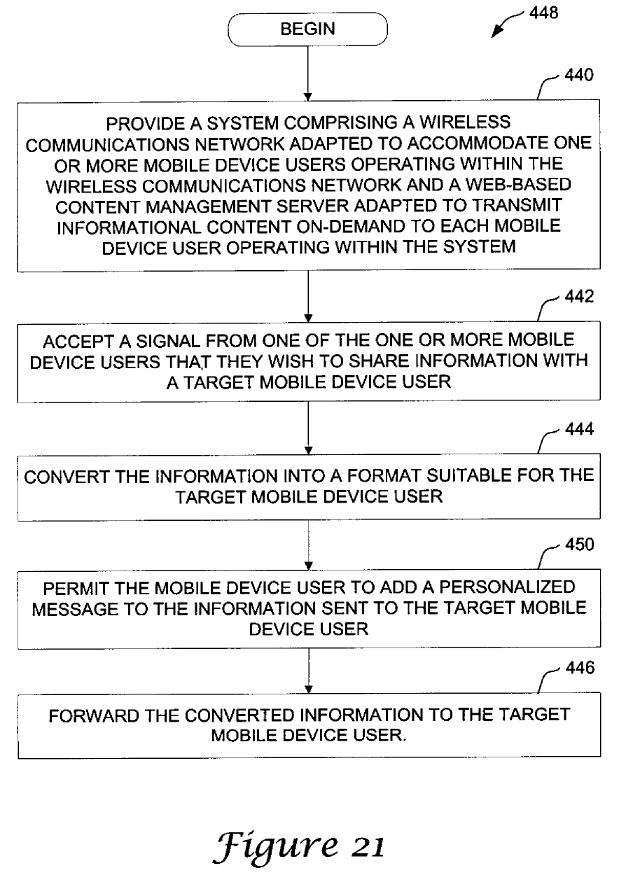

FIG. 21 shows an illustrative method 448 of providing user-to-user information exchange services. The method 438 begins generally at block 440, which describes a step of providing a system 328 that includes a wireless communications network that is adapted to accommodate one or more mobile device users 16,18,20 operating within the wireless communications network and a web-based content management server that is adapted to transmit informational content on-demand to each mobile device user 16,18,20 operating within the system.

At block 442, a signal may be accepted from one of the one or more mobile device users 16,18,20 that they wish to share information with a target mobile device user 330,332,334. Content management server 14 may convert the information into a format that is suitable for the target mobile device user 330,332,334, as shown generally at block 444. In some instances, as shown generally at block 450, the mobile device user 16,18,20 may be permitted to add a personalized message to the information before it is sent to the target mobile device user 330,332,334 at block 446.

The disclosure should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

We claim:

1. A system for providing advertising content to mobile device users, the system comprising:
a virtual advertisement network adapted to accommodate one or more advertisers operating within the virtual advertisement network;
a wireless communications network adapted to accommodate one or more mobile device users operating within the wireless communications network; and
a web-based content management server adapted to transmit advertisements and other informational content on-demand to each mobile device user opting into the system, the content management server comprising a content management engine adapted to adjust the format of the advertisements and other informational content sent to the user's mobile device based at least in part on the browser capabilities of the mobile device and/or the user's preferences.

2. The system of claim 1, wherein the content management server communicates with the virtual advertisement network.

3. The system of claim 1, wherein the content management server communicates with the wireless communications network.

4. The system of claim 1, wherein the content management engine is adapted to assist at least one of the one or more advertisers operating within the virtual advertisement network in creating the advertisements provided by the content management engine.

5. The system of claim 1, wherein the content management engine is adapted to receive information from advertisers operating within the virtual advertisement network.

6. The system of claim 1, wherein the content management engine is adapted to accept communication from the wireless communications network and/or to provide content to the wireless communications network.

7. The system of claim 1, wherein the wireless communications network is adapted to permit the one or more mobile device users to solicit information from the content management engine.

8. The system of claim 1, wherein the content management server further comprises an advertising database.

9. The system of claim 1, wherein the content management server further comprises a statistics database.

10. The system of claim 1, wherein the content management server further comprises a user profile database.

11. The system of claim 1, wherein the content management server further comprises an administrator interface.

12. The system of claim 1, wherein the content management engine is adapted to communicate with third party entities outside of the virtual advertising network and the wireless communications network.

13. The system of claim 12, wherein the content management engine is adapted to transmit real estate advertisements.

14. The system of claim 13, wherein at least one of the third party entities comprises a financial institution.

15. The system of claim 12, wherein the content management engine is adapted to transmit automotive advertisements.

16. The system of claim 15, wherein at least one of the third party entities comprises a financial institution.

17. The system of claim 15, wherein at least one of the third party entities comprises an insurance company.

18. The system of claim 15, wherein at least one of the third party entities comprises an automotive history authority.

19. The system of claim 1, wherein the content management server is adapted to provide advertisers with information pertaining to advertising effectiveness.

20. The system of claim 1, wherein the content management server is adapted to push advertisements to mobile device users who have opted to receive such advertisements.

21. The system of claim 20, wherein the content management server is adapted to solicit payment from advertisers in accordance with how many mobile device users view the pushed advertisements.

22. The system of claim 20, wherein the content management server is adapted to provide payment to the mobile device users who view the pushed advertisements.

23. The system of claim 1, wherein the content management server is adapted to accept a communication from a mobile device user within the wireless communications network and forward the communication to another mobile device user who is outside of the wireless communications network.

24. A method of enhancing vehicle sales, the method comprising the steps of:
entering an advertising agreement with an owner of a vehicle for sale;
assisting the owner in preparing an electronic advertisement for the vehicle;
providing the owner with a window cling printed with a telephone number and an identifying code unique to the vehicle, the window cling also including contact instructions;
permitting a mobile device user to text the identifying code to the telephone number as encouraged by the contact instructions on the window cling; and
providing the mobile device user with the electronic advertisement on their mobile device.

25. The method of claim 24, further comprising a step of notifying the owner of the vehicle when a mobile device user receives the electronic advertisement.

26. The method of claim 25, further comprising providing the owner of the vehicle with contact information for the mobile device user so that the owner of the vehicle may, if desired, personally contact the mobile device user to pursue a sale.

27. The method of claim 24, wherein entering an advertising agreement with an owner of a vehicle for sale comprises entering an advertising agreement with a commercial entity that has a plurality of vehicles for sale.

28. The method of claim 24, wherein assisting the owner in preparing an electronic advertisement for the vehicle comprises providing step-by-step directions, via a website, to enter information for one or more distinct categories of information that may be provided within the electronic advertisement.

29. The method of claim 28, wherein assisting the owner in preparing an electronic advertisement for the vehicle further comprises permitting the owner to associate information from a third-party entity with the electronic advertisement.

30. The method of claim 24, wherein permitting a mobile device user to text the identifying code to the telephone number comprises providing the mobile device user access to a web-based content management server adapted to transmit advertisements and other informational content on-demand to the mobile device user.

31. The method of claim 30, wherein providing the mobile device user with the electronic advertisement on their mobile device comprises customizing the electronic advertisement, based at least in part on the browser capabilities of the mobile device.

32. A method of increasing advertisement effectiveness, comprising the steps of:
providing a database of contact information for mobile device users;
soliciting approval from one or more of the mobile device users to provide them with electronic advertisements forwarded to their mobile devices in response for payment for viewing the electronic advertisements, the electronic advertisements provided by one or more advertisers;
providing electronic advertisements to the mobile device users who have opted to receive them; and
paying the mobile device users for each electronic advertisement they view.

33. The method of claim 32, further comprising steps of tracking viewing history for each of the mobile device users and reimbursing the one or more advertisers accordingly.

34. The method of claim 32, wherein soliciting approval from one or more of the mobile device users comprises obtaining demographic information from the mobile device users.

35. The method of claim 34, wherein a web-based content management server determines, in accordance with the demographic information and any criteria provided by the one or more advertisers, which electronic advertisements to provide to a particular mobile device user.

36. The method of claim 34, wherein soliciting approval from one or more of the mobile device users further comprises obtaining permission to forward the demographic information to the one or more advertisers.

37. The method of claim 36, further comprising a step of permitting the one or more advertisers to select which mobile device users will receive particular electronic advertisements.

38. The method of claim 32, wherein paying the mobile device users for each electronic advertisement they view comprises increasing the amount paid if the mobile device users buy directly from the one or more advertisers providing each electronic advertisement.

39. The method of claim 32, wherein soliciting approval from one or more of the mobile device users to provide them with electronic advertisements forwarded to their mobile devices in response for payment for viewing the electronic advertisements comprises providing a wireless signal from a remote kiosk located at or near a shopping environment.

40. The method of claim 39, wherein the remote kiosk is in communication with a web-based content management server that provides the electronic advertisements to mobile device users who choose to receive electronic advertisements in response to the wireless signal from the remote kiosk.

41. A method of providing user-to-user information exchange services, the method comprising the steps of:
providing a system comprising a wireless communications network adapted to accommodate one or more mobile device users operating within the wireless communications network and a web-based content management server adapted to transmit informational content on-demand to each mobile device user operating within the system;
accepting a signal from one of the one or more mobile device users that they wish to share information with a target mobile device user;
converting the information into a format suitable for the target mobile device user; and
forwarding the converted information to the target mobile device user.

42. The method of claim 41, wherein the information that the mobile device user wishes to share with the target mobile device user comprises an electronic advertisement.

43. The method of claim 42, wherein the web-based content management server permits the mobile device user to add a personalized message to the information sent to the target mobile device user.

44. The method of claim 42, wherein the target mobile device user is within the wireless communications network within which the one or more mobile device users are operating.

45. The method of claim 42, wherein the target mobile device user is exterior to the wireless communications network within which the one or more mobile device users are operating.
